(19) United States
(12) Patent Application Publication
(10) Pub. No.: US 2003/0158788 A1
(43) Pub. Date: Aug. 21, 2003

(54) Color conversion and standardization system and methods of making and using same

(76) Inventors: Kenneth A. Turpin, Delta (CA); Zachary T. Wickes, Burnaby (CA); Carmen C. Marin, New Westminster (CA); Christopher P. Mullen, Vancouver (CA); Yonas Jongkind, New Westminster (CA); Dobes C. I. Vandermeer, New Westminster (CA); Vic Snowden, Burnaby (CA); Yu Zhu, Vancouver (CA); Irene Vavrukh, Richmond (CA)

Correspondence Address: DUNLAP, CODDING & ROGERS P.C., PO BOX 16370, OKLAHOMA CITY, OK, 73114, US

(21) Appl. No.: 10/365,743

(22) Filed: Feb. 12, 2003

Related U.S. Application Data
(60) Provisional application No. 60/356,777, filed on Feb. 12, 2002.
(60) Provisional application No. 60/406,079, filed on Aug. 23, 2002.

(51) Int. Cl. G06F 17/60

(52) U.S. Cl. 705/26

(57) ABSTRACT

The present invention relates, in general, to a color standardization affiliation and methods of making and using same and, more particularly, to a color standardization affiliation that includes a host, a color specification system, a formulation system, and product providers capable of providing a colorable product having a desired color to a consumer.

### CROSS REFERENCE TO RELATED APPLICATIONS

This application claims priority under 35 U.S.C. §119(e) to provisional patent application U.S. Serial No. 60/356,777, entitled “COLOR STANDARDIZATION SYSTEM AND METHODS OF USING SAME”, filed Feb. 12, 2002; and provisional patent application U.S. Serial No. 60/406,079, entitled “COLOR CONVERSION AND STANDARDIZATION SYSTEM AND METHODS OF MAKING AND USING SAME”, filed Aug. 23, 2002. The entire contents of both provisional patent applications are hereby incorporated herein by reference in their entirety as though set forth explicitly herein.

### STATEMENT REGARDING FEDERALLY SPONSORED RESEARCH AND DEVELOPMENT

Not applicable.

### BACKGROUND OF THE INVENTION

1. Field of the Invention

The present invention relates, in general, to a color standardization affiliation and methods of making and using same and, more particularly, to a color standardization affiliation that includes a host, a color specification system, a formulation system, and product providers capable of providing a colorable product having a desired color to a consumer.

2. Brief Description of the State of the Background Art

Due to the growing popularity of custom projects and creative designs which are tailored to specified color palettes of architects, designers, and consumers, the construction materials industry has a high demand for variety in the colors of its colorable products, as well as matching colors across multiple colorable products, such as for example but not by way of limitation, paint, stain, concrete, glass, plastics, textiles, brick, stucco, grout, sealant, and caulk. Traditionally, it has been very costly and time consuming to create and/or match custom colors for one or multiple materials. Each individual sector in the industry adds more costs and creates more inventories in order to supply colored products. As a result, only a limited number of color choices are provided by any one sector, including, notably the paint industry, thereby limiting consumers, such as contractors, architects, designers, individuals or companies, to a limited selection of colors chosen and controlled explicitly by each sector of the industry.

Therefore, a need exists for a simplified method of standardizing color across multiple materials to facilitate and ease the production of colored products as specified by a consumer.

### SUMMARY OF THE INVENTION

The present invention relates to a system for converting color information for a color within one of the color spaces well known in the art, or any other color space as yet un-invented which can be expressed relative to any other known color space, such as for example but not by way of limitation, RGB, CMYK, HAV, HSB, HTML, LUV, LAB, SCF, XYZ, and Bradford-RGB color spaces, into one standardized code which is comprised of encrypted data that is indicative of the color. The code provides color information which can be used to formulate colorant combinations for coloring one or more colorable products, such as paint, caulk, cement, cosmetics, textiles, or the like. The code can be used in a method for directing consumers, as qualified customers, to product providers within an affiliation.

The affiliation includes one or more product providers, such as retailers, wholesalers, or the like. The product providers are capable of receiving the code and producing or providing the colorable product having the color represented by the code. Examples of typical product providers include paint stores, home improvement centers, and department stores.

A consumer is provided with a color specification system such as a computer and software. The color specification system allows the consumer, e.g. an individual or architect, to specify or generate a desired color for the colorable product and thereby supply color information about the desired color to the color specification system. The color specification system converts the color information into the code and provides the code to the consumer. For example, the code can be printed or displayed. Once the consumer has received the code, the consumer is directed to communicate the code to a product provider within the affiliation who has the capability of decoding the code through the use of a formulation system, such as a computer and software. Once the product provider receives the code from the consumer, the product provider supplies the code to the formulation system which then decodes the code to obtain the color information contained within the code.

The formulation system utilizes the color information to develop a formula detailing the combination and amounts of a plurality of colorants and possibly, but not necessarily, base materials in a set of predefined colorants, dyes and base materials that, when used to color the colorable product, will cause the colorable product to have the desired color. The product provider then uses the formula to make the specified colorable product having the desired color and provides the same to the consumer. The product provider may provide the specified product to the consumer in exchange for consideration from the consumer.

In one preferred embodiment, the color code can be used for obtaining more than one type of colorable product having the desired color. In this embodiment, the color specification system and/or the host directs the consumer to a first product provider for one type of specified colorable product to be obtained utilizing the color code and directs the consumer to a second product provider for another type of specified colorable product to be obtained utilizing the color code. The first product provider, for example, can be a paint or home improvement store for providing paint to the consumer, and the second product provider can be a supplier of grout, cement or cosmetics.

In a preferred embodiment, the present inventions allow the color specification system and the formulation system to be provided to the consumer and product providers, respectively, by a host of an affiliation, wherein the affiliation comprises the host, the product providers, and the consumers. Further, the host can provide other services to the consumers and product providers, such as developing, updating, and marketing the color specification system and formulation system. The host can also monitor exchanges between the product providers and the consumers for the purpose of billing the product providers for supplying the colored product to the consumer.

The advantages and features of the present invention will become apparent to those skilled in the art when the following description is read in conjunction with the attached drawings and the appended claims.

### BRIEF DESCRIPTION FOR THE SEVERAL VIEWS OF THE DRAWINGS

FIG. 1 is a diagram of an affiliation constructed in accordance with the present invention.

FIG. 2 is a block diagram of a computer that provides the operating environment for a color specification system of the present invention.

FIG. 3 shows an exemplary selector main menu for a specifier user interface utilized by the color specification system of the present invention.

FIG. 4 shows an exemplary CBN Image Editor sub-menu utilized by the color specification system of the present invention.

FIG. 5 shows an exemplary Get Image sub-menu utilized by the color specification system of the present invention.

FIG. 6 shows an image displayed with the Get Image sub-menu of FIG. 5.

FIG. 7 shows an exemplary Create Color Areas sub-menu with an image having color areas displayed therein.

FIG. 8 shows an exemplary color area sub-menu within the Create Color Areas sub-menu of FIG. 7.

FIG. 8A is a diagrammatic representation of one preferred embodiment of an image file constructed by the specifier program in accordance with the present invention.

FIG. 9 shows an exemplary Preview sub-menu with the image having colored color areas and an original image displayed therein.

FIG. 10 shows an exemplary color selector that displays a database of selectable colors as a three-dimensional representation.

FIG. 11 shows an exemplary enlarged portion of the three-dimensional representation of FIG. 10.

FIG. 12 shows an exemplary gradient representation of the color selector of the present invention.

FIG. 13 shows an exemplary color coordinates palette for the color selector of the present invention.

FIG. 14 shows an exemplary color chart for the color selector of the present invention.

FIG. 15 shows an exemplary user color list for the color selector of the present invention.

FIG. 16 shows an exemplary convert panel for the color selector of the present invention.

FIG. 17 shows an exemplary pixel specifier for the color selector of the present invention.

FIG. 18a is a graphical representation of the various color spaces which are encompassed by the span of color codes generated using the present invention.

FIG. 18B is a flow chart illustrating one preferred embodiment for generating a color code in accordance with the present invention.

FIG. 19 shows an exemplary assistant main menu for a specifier user interface utilized by the color specification system of the present invention.

FIG. 20 shows an exemplary wall label.

FIG. 21 shows an exemplary room label.

FIG. 22 shows an exemplary plan specification window.

FIG. 23 shows an exemplary color specification report.

FIG. 24 is a block diagram of a computer that provides the operating environment for a formulation system of the present invention.

FIG. 25 shows an exemplary formulator main menu for a formulator user interface utilized by the formulation system of the present invention.

FIG. 26 shows an exemplary Input CBN field utilized by the formulation system of the present invention.

FIG. 27 shows an exemplary formula produced by the formulation system of the present invention.

FIG. 28 shows an exemplary Enter Quantity field and a Units field utilized by the formulation system of the present invention.

FIG. 29a is a logic flow diagram illustrating a main logic loop for generating a formula.

FIG. 29b is a logic flow diagram illustrating an alternate embodiment for generating a formula using heuristic criterion.

FIG. 29c is a graph of a heuristic criterion representing the “cost” of the total amount of colorant in a given formula.

FIG. 29d is a graph of a heuristic criterion representing the “cost” of the quality of a given formula relative to hide and color fastness.

FIG. 29e is a graph of a heuristic criterion representing the estimated monetary cost of the colorants in a given formula.

FIG. 29f is a graph of a heuristic criterion representing the “cost” of the estimated match distance in a given formula to desired color.

FIG. 29g is a graph of a heuristic criterion representing the “cost” of the number of pigments in a given formula.

FIG. 30 shows an exemplary formulation color specification system incorporated into the formulator main menu of FIG. 25.

FIG. 31 shows an exemplary Choose From Color Book sub-menu utilized by the formulation system of the present invention.

FIG. 32 shows an exemplary Create New Color sub-menu utilized by the formulation system of the present invention.

FIG. 33 shows an exemplary Convert Color From RGB sub-menu utilized by the formulation system of the present invention.

FIG. 34 shows an exemplary Scan Color From Spectrometer sub-menu utilized by the formulation system of the present invention.

FIG. 35 shows an exemplary customer purchase information panel utilized by the formulation system of the present invention.

FIG. 36 shows an exemplary Find Saved Job sub-menu utilized by the formulation system of the present invention.

FIG. 37a is a logic flow diagram of the process of modifying a pixel's color based upon the overall grayscale values of a selected color area of an image.

FIG. 37b is a logic flow diagram of the process of determining and applying an object tone to a pixel of a selected color area of an image.

### DETAILED DESCRIPTION OF THE INVENTION

Before explaining at least one embodiment of the invention in detail, it is to be understood that the invention is not limited in its application to the details of construction and the arrangements of the components set forth in the following description or illustrated in the drawings. The invention is capable of other embodiments or of being practiced or carried out in various ways. Also, it is to be understood that the phraseology and terminology employed herein is for purpose of description and should not be regarded as limiting.

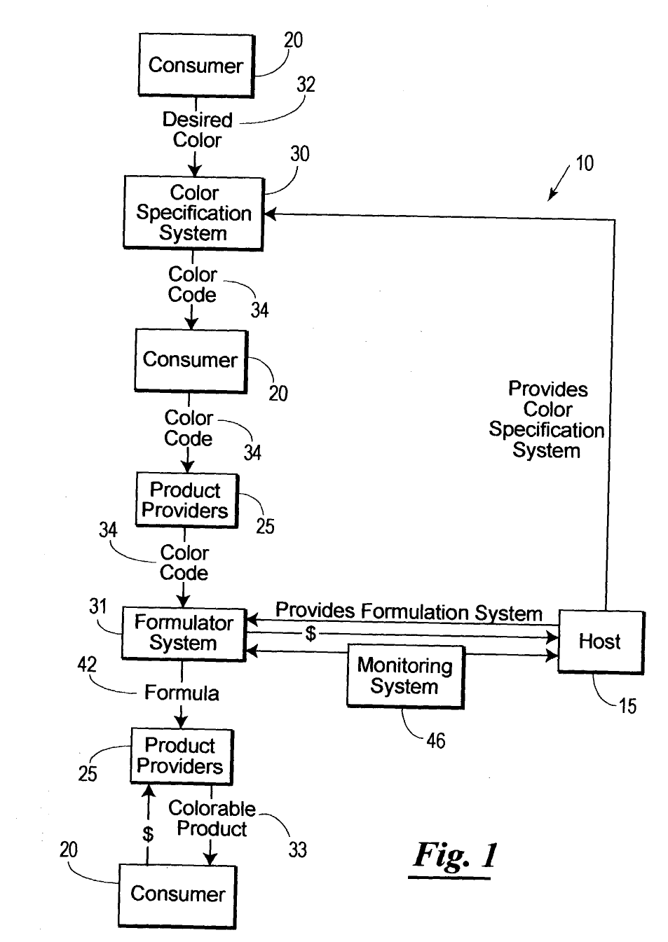

Referring now to the drawings and in particular to FIG. 1, shown therein in diagram form, is an affiliation 10, including a host 15, a plurality of consumers 20 (only one consumer 20 being shown for purposes of clarity), and a plurality of product providers 25 (only one product provider 25 being shown for purposes of clarity). The host 15 can be one or more entities, such as a company or individual, which is capable of providing a color specification system 30 to the consumer 20 and a formulation system 31 to the product provider 25.

The color specification system 30 allows the consumer 20 to specify at least one desired color 32 for at least one specified colorable product 33 and receive a color code 34. The color code 34 permits at least one product provider 25 to produce at least one specified colorable product 33 in the desired color 32. In one preferred embodiment, the color code 34 comprises encrypted data indicative of the desired color 32. The color code 34 is an encoding/decoding mechanism and schema for the identification, recording, communication and distribution of precise visual color information from the electromagnetic spectrum that is both universally color-space independent and universally device/representation independent. In one embodiment, a single 12-digit color code 34 allows representation of in excess of 1.15×10¹⁸ (or 1.15 quintillion) individually identifiable and measurable colors. More precisely, the color code 34 in this embodiment allows measurement, identification, communication and precise one-to-one mapping of in excess of 1.15×10¹⁸ individually and uniquely identifiable colors from within any color space (existing spaces or as yet undeveloped spaces) using any device (i.e. device independent) for input, measurement, transmission and representation of the colors.

In one preferred embodiment, the color code 34 forms a substantially universal color information storage medium. That is, color information from any input device can be converted into and/or represented by the color code 34. The input device can be for example, but should not be regarded as limiting, a spectrophotometer, colorimeter, camera, or any other type of device capable of producing color information utilizing known industry standards or even industry standards not yet invented (i.e. it is industry standard independent) so long as the color information is capable of being represented by or converted into a color code 34 that is relative to a host color space, as discussed in detail hereinafter. The conversion to and from the color code 34 may, in one embodiment, be accomplished on a pixel by pixel basis. Once the color information is stored in the color code 34, such color information can be transmitted to and used by any type of color output device (e.g., a printer based on CMYK color space, a monitor based on RGB or YcrCb color spaces, or a television system based on RGB color space) programmed to decode and/or otherwise read the color code 34 such that it is capable of substantially accurately representing the color encoding or represented by the color code 34. Thus, the same color code 34 can be transmitted to a monitor and converted to RGB color space, and subsequently transmitted to a printer and converted to CMYK color space, all the while maintaining the color information encoded by the color code 34.

The formulation system 31 allows the product provider 25 to utilize the color code 34 in generating a formula 42 for making a specified colorable product 33 having the desired color 32. The consumer 20 can be one or more entities which is charged with specifying a color for a colorable product, such as for example, a contractor, architect, designer, individual, company, or combination thereof. The product provider 25 can be one or more entities capable of providing the specified colorable product 33 having the desired color 32 to the consumer 20, or the agents, affiliates, or employees of the consumer 20. The product provider 25 can be, for example, a factory, distributor, retail store, manufacturer, wholesaler, or any combination(s) thereof.

The following is a brief, general description of the operations within the affiliation 10, as shown in FIG. 1. The host 15 provides the consumer 20 with the color specification system 30, and provides the product provider 25 with the formulation system 31. The consumer 20 utilizes the color specification system 30 to specify the desired color 32. The color specification system 30 generates the color code 34 and directs the consumer 20 to communicate the color code 34 to the product provider 25 (along with information about the specified colorable product 33, such as for example, information on the type of material and quantity of the colorable product 33).

In one preferred embodiment, the color code 34 can be used for obtaining more than one type of colorable product 33 having the desired color. In this embodiment, the color specification system 30 and/or the host 15 direct the consumer 20 to a first product provider 25 for one type of specified colorable product 33 to be obtained utilizing the color code 34 and also directs the consumer 20 to a second product provider 25 for an additional (such as a second or third, etc.) type of specified colorable product 33 to be obtained utilizing the color code 34. The first product provider 25 can, for example, be a paint or home improvement store for providing paint to the consumer 20, and the second product provider 25 can be a supplier of grout, cement or cosmetics, for providing grout (or any colorable material) to the consumer 20 such that the color of the grout is substantially the same as the paint (or even the cosmetic as the color code 34 is material independent). The first and second product providers 25 can either be separate entities or the same entity having different divisions.

The product provider 25 utilizes the formulation system 31 in conjunction with the color code 34 to generate the formula 42 which can be utilized for making the specified colorable product 33 having the desired color 32. Once the product provider 25 makes and provides the specified colorable product 33 having the desired color 32 to the consumer 20, the consumer 20 will generally give the product provider 25 some consideration, such as for example, money, in exchange for the specified colorable product 33 having the desired color 32.

As an optional feature of the invention, the host 15 can bill the product provider 25 for any use of the formulation system 31 at an agreed upon rate, e.g. twenty-five cents per gallon of paint. The host 15 can optionally bill the product provider 25 for other expenses incurred in operating the affiliation 10, such as by way of example but not limitation, providing the consumer 20 with the color specification system 30, providing the product provider 25 with the formulation system 31, directing the consumer 20 to one or more qualified product providers 25 within the affiliation 10, maintaining the affiliation 10, providing customer support, and updating the color specification system 30 and formulation system 31, and/or the host 15 can charge the product provider 25 fees for membership to the affiliation 10, such as, by way of example but not by way of limitation, licensing fees, royalty fees, training fees, and maintenance fees.

Further, a monitoring system 46 that is capable of reporting on exchanges between the consumers 20 and the product providers 25 may be included. The monitoring system 46 may be further capable of noting and conveying (to the affiliation 10, host 15, product providers 25, etc.) royalty fee calculation figures. The monitoring system 46 may also be capable of storing and conveying information concerning and market feedback that the affiliation 10, host 15, and/or product provider 25 may assess in order to determine any modifications or further maintenance that may be desired by or advantageous to the affiliation 10. In such an embodiment, the monitoring system 46 can include a component for counting and collecting the host 15 revenue stream, a market success analysis system, and/or an application program interface which allows product providers 25 to integrate the monitoring system 46 into their own business system. The monitoring system 46 can be incorporated into the formulation system 31. One of ordinary skill in the art, given the present specification, would appreciate and understand the utility of such a monitoring system 46 in use with the affiliation 10 such that the monitoring system 46 would be within the scope of any particular embodiment of the affiliation 10.

Although the host 15 is referred to as billing or charging the product provider 25, it will be understood that the host 15 may also bill or charge the consumer 20 for services provided to the consumer 20, such as for example, providing the consumer 20 with the color specification system 30. However, in order to encourage a wide distribution or number of consumers 20 to participate in the affiliation 10 and/or adopt the affiliation 10, the color specification system 30 is preferably provided to the consumers 20 at no charge and/or may even be provided to the consumers 20 at a negative cost to the host 15 and/or the product providers 25. The term “negative cost” includes the use of such incentives as may be necessary in order to entice a wider distribution of consumers 20 to adopt the use of the affiliation 10 such as, for example but not by way of limitation, coupons, rebates, discounts of products and/or direct compensation programs whereby the host 15 and/or the product providers 25 provide some sort of direct compensation to the consumers 20 who adopt and/or use the affiliation 10.

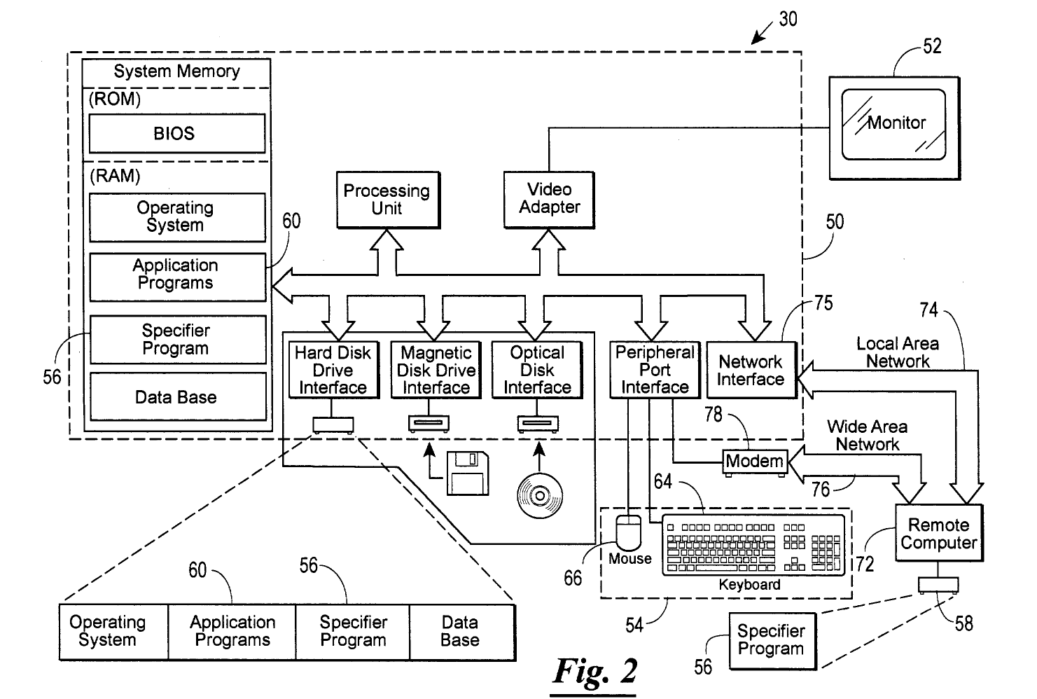

Referring now to FIG. 2, shown therein in block diagram form, is a representation of one preferred embodiment of the color specification system 30 constructed in accordance with the present invention. The color specification system 30 includes a computer 50, a monitor 52, an input device 54, and a specifier program 56. This embodiment of the color specification system 30 is but one example thereof, and modifications thereto are to be considered as within the scope of the color specification system 30.

In particular, the following discussion is intended to provide a brief, general description of a suitable computing environment in which the invention may be implemented. Moreover, those skilled in the art will appreciate that the invention may be practiced with other computer system configurations, including hand-held devices, multi-processor systems, micro-processor based or programmable consumer electronics, mini computers, mainframe computers and the like. The invention may also be practiced in distributed computing environments where the tasks are performed by one or more remote processing devices that are linked through a communications network. In a distributed computing environment, the specifier program 56 may be located in a local and/or a remote memory storage device 58.

A number of software programs, including application programs 60 and the specifier program 56 may be stored in the computer 50. The consumer 20 may enter commands and information into the computer 50, through one or more input devices 54, such as a keyboard 64 and/or a pointing device, such as a mouse 66 and/or a pen tablet or any other stylus based device, which are connected to the computer 50. The input devices 54 may also include a microphone, joy stick, game pad, satellite dish, digital camera, scanner, spectrometer, spectrophotometer, or the like (not shown). The monitor 52 (such as an LCD, flat screen, television, or other type of display device) is also connected to the computer 50. In addition to the monitor 52, the computer 50 typically includes other peripheral output devices, such as speakers (not shown) or a printer, including generic printers, laser printers, ink jet printers, daisy wheel printers, black and white copiers, color copiers, and read-write cdROMS (not shown).

The computer 50 may operate in a networked environment using logical connections to one or more remote computers, such as a remote computer 72. The remote computer 72 may be a server, a router, a peer device or other common network node and typically includes many or all of the elements described relative to the computer 50, although only the remote memory storage device 58 has been illustrated in FIG. 2. The logical connections depicted in FIG. 2 include a local area network (LAN) 74 and a wide area network (WAN) 76. Such networking environments are commonplace in offices, enterprise-wide computer networks, intra-nets and the Internet and one of ordinary skill in the art would be able to replicate and/or expand upon such systems given the present specification.

When using the local area network (LAN) 74, the computer 50 is connected to the local area network (LAN) 74, through a network interface 75. When used in the wide area network (WAN) 76, the computer 50 typically includes a modem 78, or other means for establishing communications over the wide area network (WAN) 76, such as the Internet. In a network environment, the specifier program 56, depicted relative to the personal computer or portions thereof, may be stored in the memory storage device 58. It will be appreciated that the network connections shown are exemplary and other means of establishing a communication link between the computers may be used.

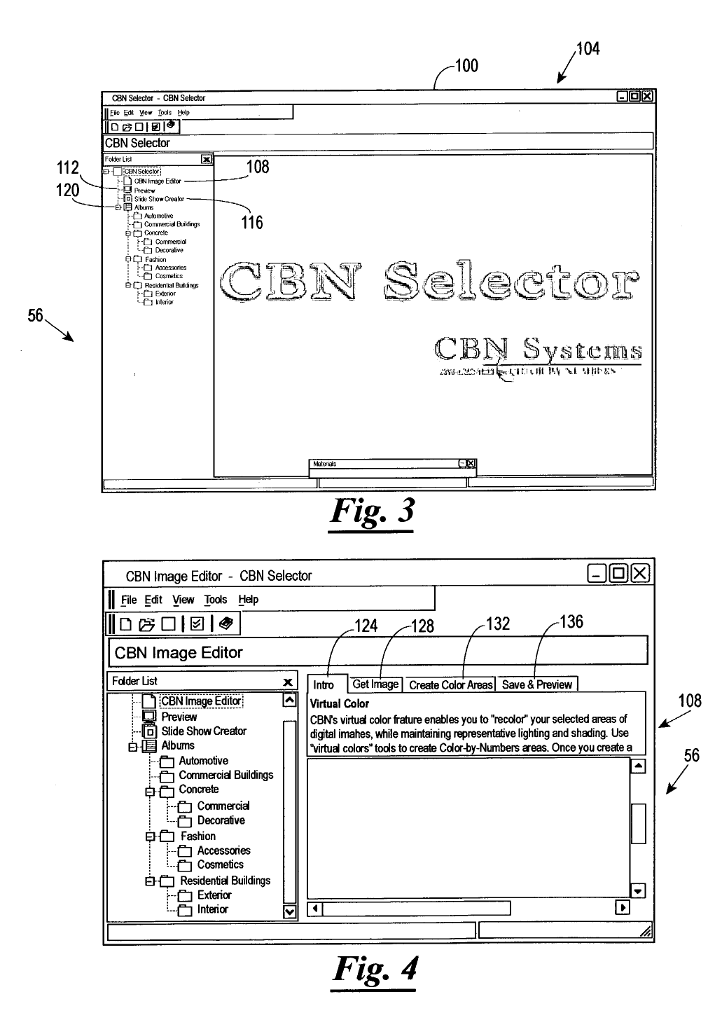

The specifier program 56, one exemplary and preferred embodiment of which is shown in FIG. 3, provides a user interface which allows the consumer 20 to input information about the desired color 32 for the colorable product 33 into the specifier program 56 by using the input device 54 and the computer 50, and then outputs the color code 34, which comprises encrypted data indicative of the desired color 32, so as to provide the consumer 20 with the color code 34. The specifier program 56 generally outputs the color code 34 to the monitor 52, but can also output the color code 34 to the output device, such as the printer. The monitor 52 can be any type of device capable of displaying information. For example, the monitor 52 can be an LCD device, CRT device, LED device or the like.

In one preferred embodiment of the specifier program 56, the specifier program 56 comprises stand-alone software which does not require third party software to operate. In such an embodiment, the specifier program 56 can provide the consumer 20 with a specifier user interface, as shown in FIG. 3. More specifically, shown for example in FIG. 3, is a selector main menu 100 for a specifier user interface 104, constructed in accordance with the present invention.

The selector main menu 100 provides various user tools to aid the consumer 20 in specifying a color. For example, but not by way of limitation, the specifier program 56 can allow the consumer 20 to display, select, alter, and encode to the color code 34 the colors within an image, such as a digital or scanned photograph, and store such images on the computer 50 in order: (1) to display such images in a sequential order in a slide show format; (2) to pick a color from a list; (3) to pick a color found within an image; and (4) to coordinate a plurality of colors.

In the embodiment of the specifier program 56 shown in FIG. 3, the selector main menu 100 includes a listing for selecting a CBN Image Editor sub-menu 108, a listing for selecting a Preview sub-menu 112, a listing for selecting a Slide Show Creator sub-menu 116, and a listing for selecting an Albums sub-menu 120.

Referring now to FIG. 4, the CBN Image Editor sub-menu 108 includes a tab for selecting an Intro sub-menu 124, a tab for selecting a Get Image sub-menu 128, a tab for selecting a Create Color Areas sub-menu 132, and a tab for selecting a Save and Preview sub-menu 136. The Intro sub-menu 124 can be used to provide the consumer 20 with general introductory information, such as for example, an overview of the capabilities of the specifier program 56.

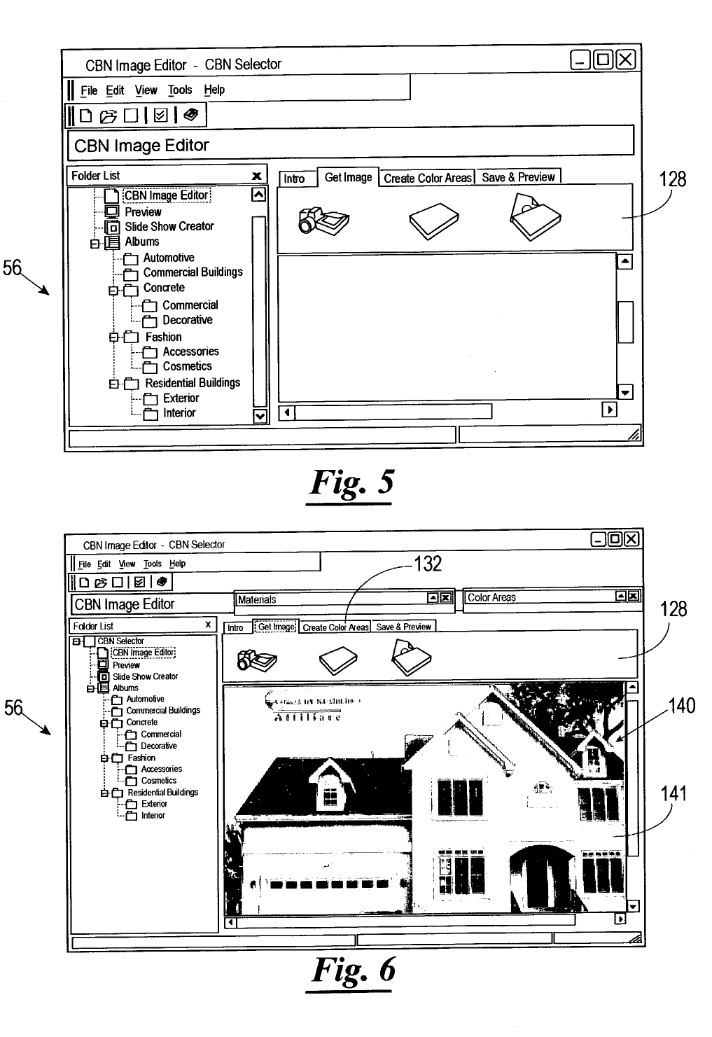

Utilizing the Get Image sub-menu 128 (see FIG. 5), the consumer 20 can load an image into an editor incorporated within the specifier program 56 by selecting from predefined functions for loading an image into the editor, such as by way of example but not limitation, acquire from a scanner or digital camera, open a saved file, and open a previously opened file. Once an image has been loaded into the editor, the image can be displayed within the Get Image sub-menu 128, as shown in FIG. 6. Any means for loading an image into an editor within the specifier program 56 is considered to be within the scope of the specifier program 56.

Referring to FIG. 6, an image 140 is displayed within the Get Image sub-menu 128. Any one or combination of shapes, figures, patterns, objects, etc., can be displayed within the image 140, such as by way of example but not limitation, a house interior or exterior, a building interior or exterior, a car interior or exterior, a driveway, a roadway, a bridge, a wood grain sample, a pattern or texture swatch, a person, a shoe, an article of clothing, a cosmetic product, a food product, or a painting. For example, the image 140, as shown in FIGS. 6-9, displays a house exterior 141 (and other objects, such as foliage and/or other botanical items that are adjacent to but perhaps ancillary to the house exterior 141).

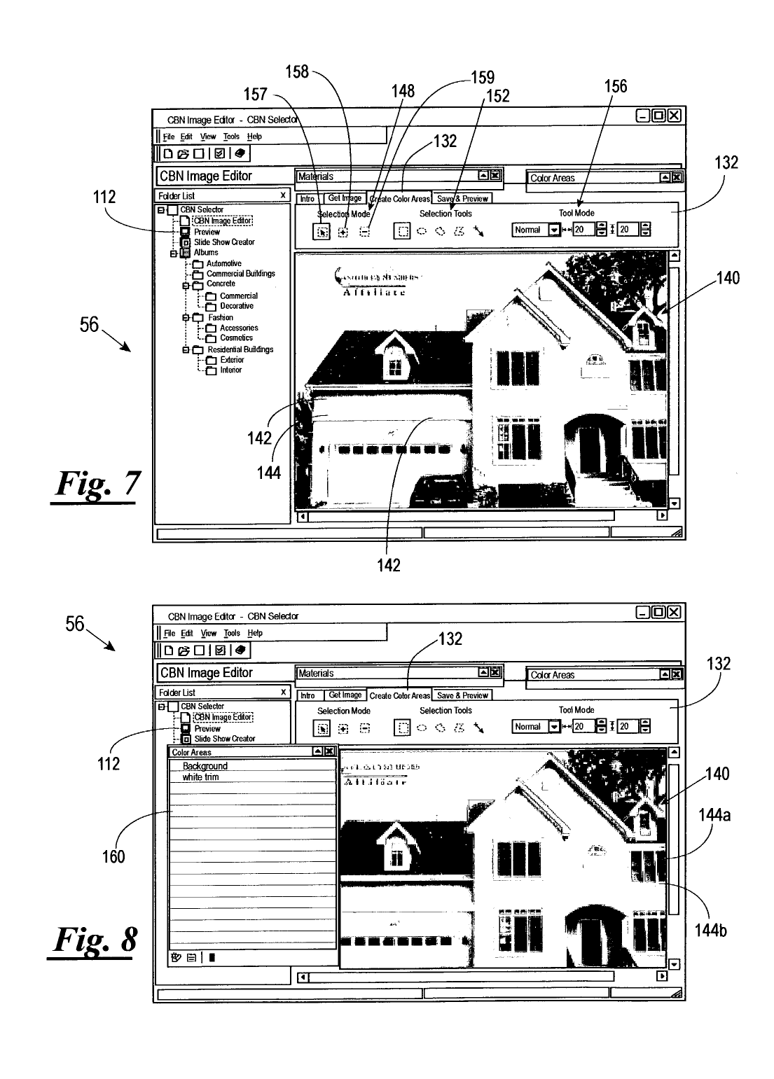

Once the consumer 20 has loaded the image 140 into the editor, the consumer 20 then utilizes the Create Color Areas sub-menu 132 (see FIG. 7), in conjunction with the input device 54, such as the mouse 66, to select or deselect one or more areas within the image 140 to form selected areas 142. The selected areas 142 collectively form a color area 144, wherein the color area 144 designates one or more areas within the image 140 that the consumer 20 will be able to later modify within the editor utilizing the Preview sub-menu 112, as discussed in further detail below. The Create Color Areas sub-menu 132 can be constructed so as to allow the consumer 20 to create one or more color areas 144. For example, the consumer 20 can create one color area 144 for the house's trim and another color area 144 for the house's facing.

As shown in FIG. 7, in one preferred embodiment, the consumer 20 selects or deselects areas within the image 140 by using predefined selection methods and/or predefined selection tools. The consumer 20 can select predefined parameters and/or set characteristic values for the predefined selection methods by using a selection mode field 148, a selection tools field 152, and a tool. mode field 156, which can be displayed in the Create Color Areas sub-menu 132.

The selection mode field 148 can be used to select which mode the selection will be made by the consumer 20, such as by way of example but not limitation, normal mode 157, wherein only the area 142 selected by the consumer 20 within the image 140 will be designated as the color area 144, or additive mode 158, wherein each consecutive selected area 142 will be added to any area that was previously selected by the consumer 20, or subtractive mode 159, wherein each consecutive selected area 142 will be subtracted, or excluded, from any area that was previously selected by the consumer 20. The selection tool field 152 can be used to select a selection tool format in which an area will be selected by the consumer 20, such as by way of example but not limitation, a rectangle format, a circle format, a free-hand format, a polygon format, and/or any other type of user defined format, such as one determined by an HSB or RGB rating. Each of these select tool formats are well known in the art and may be partially and/or wholly found in Adobe System's software product Photoshop®. The tool mode field 156 can be used to set format characteristics in a manner well known in the art as well.

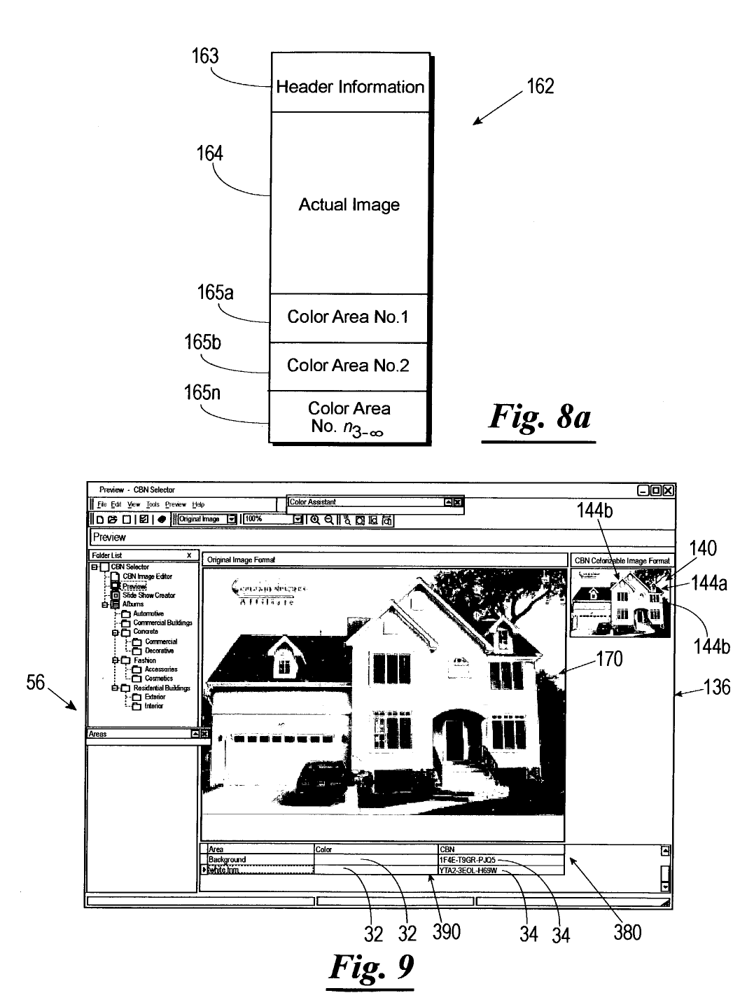

As shown in FIG. 8, within the Create Color Areas sub-menu 132, other menus, sub-menus, and fields can be provided so as to allow the consumer 20 to create and further label, describe, and/or select multiple separate color areas 144 within the image 140. That is, shown in FIG. 8 is a color area sub-menu 160 for the image 140 displayed within the Create Color Areas sub-menu 132. The color area sub-menu 160 displays the labels for a plurality of color areas 144, such as a background color area 144a and a white trim color area 144b. The color area sub-menu 160 can also display a description of the color areas 144, or such information can be displayed in a separate sub-menu. The color area sub-menu 160 can further allow for the consumer 20 to hide or display one or more of the color areas 144 within the image 140 so as to allow each color area 144 to be readily identifiable and to be more easily selected for each color area 144.

By selecting and creating color areas 144 within the image 140, the consumer 20 indicates to the specifier program 56 which portions of the image 140 are to be modifiable within the editor utilizing the Preview sub-menu 112. In one embodiment, in order to modify the portions of the image 140 within the color areas 144, the specifier program 56 collects image information, such as lighting, shading, or texture for the image 140 to create shading and highlighting information indicative of the shading and highlighting conditions within the image 140. Further, the specifier program 56 can collect other image information for the image 140 and/or each color area 144, such as for example, image size, creation date, author, comments, material type associated with the color area 144, region data for the color area 144, and combinations thereof.

In one embodiment, the specifier program 56 creates a grayscale overlay indicative of the shading and highlighting information in the image 140. The desired color 32 is added to at least one of the color areas 144 along with the information indicative of the shading and highlighting conditions within the image 140 to simulate the real-world look of the desired color 32 in the image 140. Such a “real-world” look of the desired color 32 in the image 140 may be saved in a file format (described hereinafter in detail).

In one preferred embodiment, the specifier program 56 hides, or encrypts, the shading and highlighting information for the image 140 in the grayscale of the image file through the use of the technique of steganography, which is well known to a person of ordinary skill in the art, and therefore, further detailed discussion of the technique of steganography is not deemed necessary. However, briefly, steganography is the art and science of hiding information by embedding data within another computer file by replacing bits of useless, insignificant, or unused data in regular computer files (such as graphics, sound, text, HTML, or even floppy disks) with bits of different, hidden information. This hidden information can be plain text, cipher text, or even images. Alternatively, the specifier program 56 can collect and hide image information for the portions of the image 140 within the color areas 144, rather than for the entire image 140.

In another embodiment, in order to modify the portions of the image 140 within the color areas 144, the specifier program 56 assigns RGB values to the pixels in the color area 144 wherein the RGB value assigned to one of the pixels in the color area 144 is determined by the RGB value of the desired color 32 and that pixel's grayscale value in relation to the other pixels in the color area 144. In this embodiment, the specifier program 56 determines the RGB value of each of the pixels in the color area 144 of the unmodified image 140, converts the RGB values into grayscale equivalents, and then constructs a grayscale histogram so as to find the distribution of grayscale tones within the image 140.

In one preferred embodiment, the grayscale tone having the maximum corresponding number of pixels is considered to be the object tone, whereby each pixel having that grayscale tone is assigned the RGB value of the desired color 32. From the grayscale tone with the maximum number of pixels, a scaling factor is determined by which the grayscale tone of each of the remaining pixels are scaled or normalized by, then the scaled grayscale tone of each pixel-is used to adjust the RGB value of the desired color 32 so as to give each pixel a color with a higher or lower shade/brightness than the desired color 32, thereby giving the effect of the desired color 32 being “shaded” or “highlighted” in any one of the particular pixels depending on the relationship of the pixel's grayscale tone relative to the grayscale tone with the maximum number of pixels in the grayscale histogram. By assigning different colors to the shaded and highlighted areas according to relative and normalized grayscale tones in the image 140, shape definitions in the image 140 due to shadowing and lighting are maintained, giving a more true and “real-life” representation of the objects in the color areas 144 in the image 140 that have to be changed to exhibit the desired color 32.

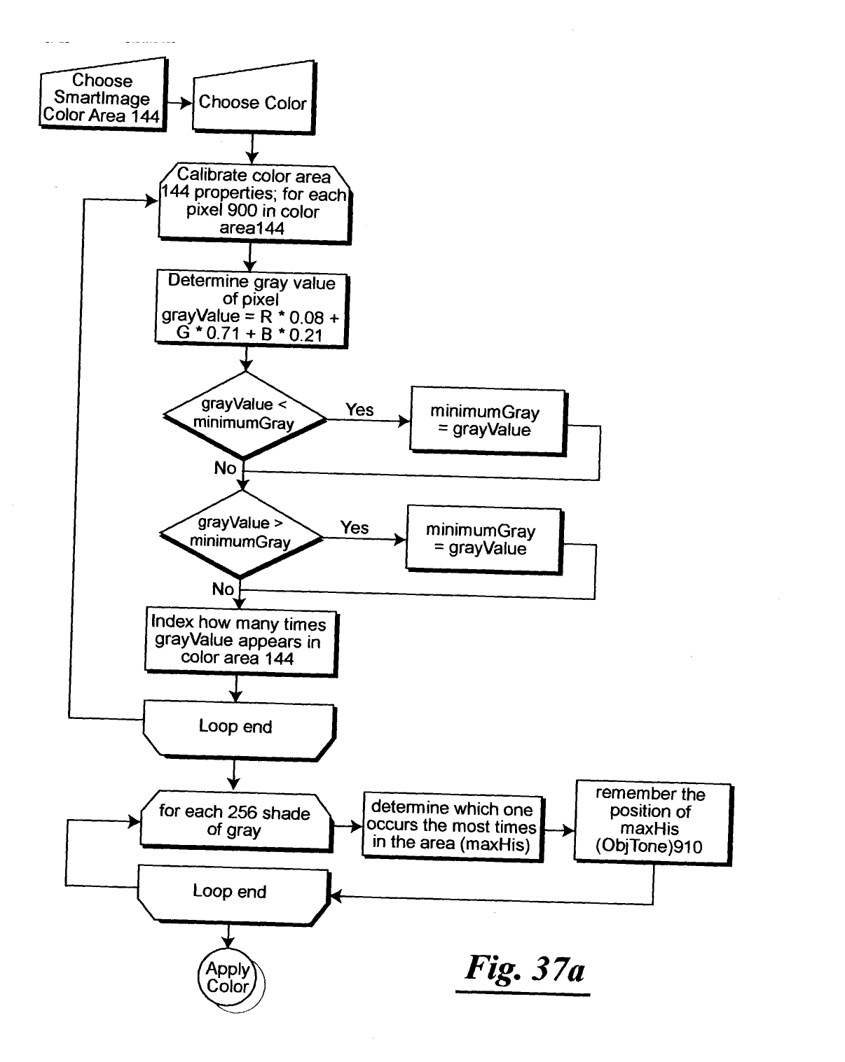

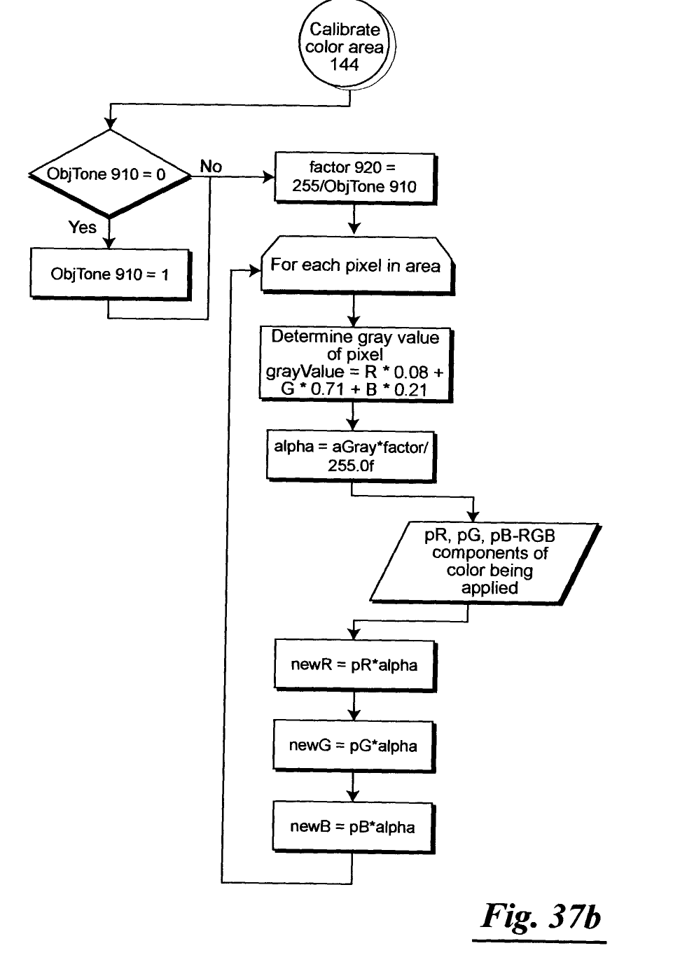

The process by which the image is analyzed is described in FIGS. 37a and 37b. After choosing a given color area 144, each pixel 900 of the color area 144 is analyzed and converted into grayscale using the following formula that is well known in the art: grayvalue=R component*0.08+G component*0.71+B component*0.21. Upon traversing and analyzing each pixel 900, the smallest and the highest gray shade values are determined and the number of times each value occurs is noted. The value that has the highest number of occurrences determines what is called the “object tone” 910.

The object tone 910 is used to calculate a factor 920 by which the rest of the colors contained in the color area 144 (also known as the “SmartImage Area”) will be adjusted by the factor which is calculated by dividing 255 (number of shades of gray) by the object tone 910. Upon determining the factor 920, once again the gray value of each pixel in the color area 144 is determined and the color dependent factor 930 (“Cf”) is adjusted as follows: Cf=gray value multiplied by the factor 920, wherein the factor 920 has been divided by 255. Finally, the new color is computed by applying the Cf factor 930 to each color component of the original image pixel (i.e. each RGB value) in the following manner: new R component=original R component multiplied by the Cf factor 930, new G component=original G component multiplied by the Cf factor 930, new B component=original B component multiplied by the Cf factor 930.

Example: desired color: RGB=(199, 42, 21). Based on area analysis, maxGray=120, minGray=73, ObjectTone=91. Factor=255/ObjTone<=>Factor=2.80. Original RGB for pixel=(22, 111, 167). Using above mentioned formula for calculating gray value of pixel we have GrayValue=115.64. Cf=gray value*factor/255<=>Cf=115.64*2.80/255<=>Cf=1.269. Finally, Cf applied to each component of the color being applied gives us the following results: newR=originalR*Cf<=>newR=199*1.269<=>newR=252.31; newG=originalG*Cf<=>newG=42*1.269<=>newG=53; newB=originalB*Cf<=>newB=21*1.269<=>newR=26.64.

The factor 920 can also be calculated by dividing the number of grayscale tones less one by the grayscale value of the grayscale tone with the maximum number of pixels. In a preferred embodiment, if a second maximum occurs within the grayscale histogram, the grayscale tone with the second maximum number of pixels is assigned the desired color 32 and used to determine the factor 920 for the remaining pixels rather than the grayscale tone with the maximum number of pixels. This prevents overcompensation of the factor 920 if the image 140 was created in an environment with overly lighted lighting conditions or under lighted lighting conditions. Further, in order to increase aesthetic quality of the color areas 144 modified by the factor 920, the specifier program 56 can identify pixels along the edge of the color area 144 and perform a procedure, well known in the art that is known as anti-aliasing, to the edge pixels of the color area 144 so as to provide a smoother transition from the edge pixels of the color area 144 to the adjacent pixels of the image 140. This technique is well known to one or ordinary skill in the art and thus needs no further explanation.

The image 140 and the hidden image information (such as the object tone 910, factor 920, and Cf factor 930) are desirably stored as a single modifiable image file with an identifying file extension (such as for example, “.CBN”). By utilizing a single modifiable image file, the present invention eliminates the need for excessive storage space as with prior art modifiable images which require an additional file created to view modifications and/or print the image in some form of the CMYK printer language wherein both of these files are sent to the printer for processing. The specifier program 56 can further be developed such that only the software of the specifier program 56 can read and process the hidden image information within the modifiable image file having the identifying file extension.

A diagrammatic representation of one preferred embodiment of an encrypted image file 162 constructed by the specifier program 56 in accordance with the present invention is shown in FIG. 8A. The encrypted image file 162 is provided with a header section 163, an image section 164, and one or more smart image sections 165, wherein the smart image sections 165 comprise the color area 144 and are defined by mathematical algorithms that define rectangles so as to “mask” the color area 144. Two smart image sections 165 are shown in FIG. 8A and labeled with the reference numerals 165a and 165b for purposes of clarity. The header section 163 includes information describing the image 140 stored in the image section 164, as well as other information, such as the creation date, size (in bytes) and author of the image 140, as well as comments. The image 140 is preferably a .JPEG image, although it may be a .TIFF, .RTF, or any other suitable image format known to one of ordinary skill in the art.

Each smart image section 165 corresponds to one of the color areas 144 defined in the image 140. Each smart image section 165 contains information regarding one specific color area 144. Thus, if the image 140 contains two color areas 144, the encrypted image file 162 will include two smart image sections 165a and 165b. Each of the smart image sections 165a and 165b include a collection of information that define each color area 144. In one preferred embodiment, each smart image section 165 includes name, comments, and material type, area information (i.e. the area selected or masked utilizing the create color areas sub-menu 132), and desired color 32 or color code 34. The area information is typically a plurality of rectangles whose combined area substantially defines or masks the color area 144. The area information can be produced utilizing the Windows command “GetRegionData” as is well known to those of ordinary skill in the art.

The image file 162 allows digital images to be imported such that any number of color areas 144 (e.g., 1, 2, 3 or more) can be defined and associated with arbitrary, but logical, surface areas within the image 140. Subsequently, the specifier program 56 processes the image 140 and applies to the associated color areas 144 within the image 140, the associated desired color 32 in a manner such that the perceived texture, depth, shadow, highlight and other spatial features of the image 140 are preserved (see e.g. FIGS. 37a and 37b and associated written description herein). This provides a user (such as the consumer 20) with the ability to realistically visualize the desired color 32 being applied to the arbitrary surface areas or color areas 144 of the image 140.

Once the consumer 20 has selected the desired color areas 144 within the image 140, the consumer 20 then utilizes the Save and Preview sub-menu 136 to select predefined save options displayed in the Save and Preview sub-menu 136. The consumer 20 then saves the image 140 with the color areas 144 as a file with an identifiable file extension, such as for example, “.cbn”, thereby creating a smart image file, such as encrypted image file 162. The consumer 20 is then queried on a category that can be assigned to the smart image file, such as by way of example and not limitation, a category of automotive, commercial building, concrete, commercial concrete, decorative concrete, fashion, fashion accessories, fashion cosmetics, residential buildings, residential buildings interior, residential buildings exterior, patterns, textures, and wood grains, so that the smart image file may be made readily identifiable and available to the consumer 20 via the Albums sub-menu 120. The consumer 20 can retrieve the smart image file within a plurality of smart image files stored in different albums, or sub-folders, and specify the image 140 with color areas 144 to be used in the Preview sub-menu 112 as discussed in more detail below, and/or in the Slide Show Creator sub-menu 116. By utilizing the Slide Show Creator sub-menu 116 and the Albums sub-menu 120, a plurality of images 140 can be displayed in a sequential fashion.

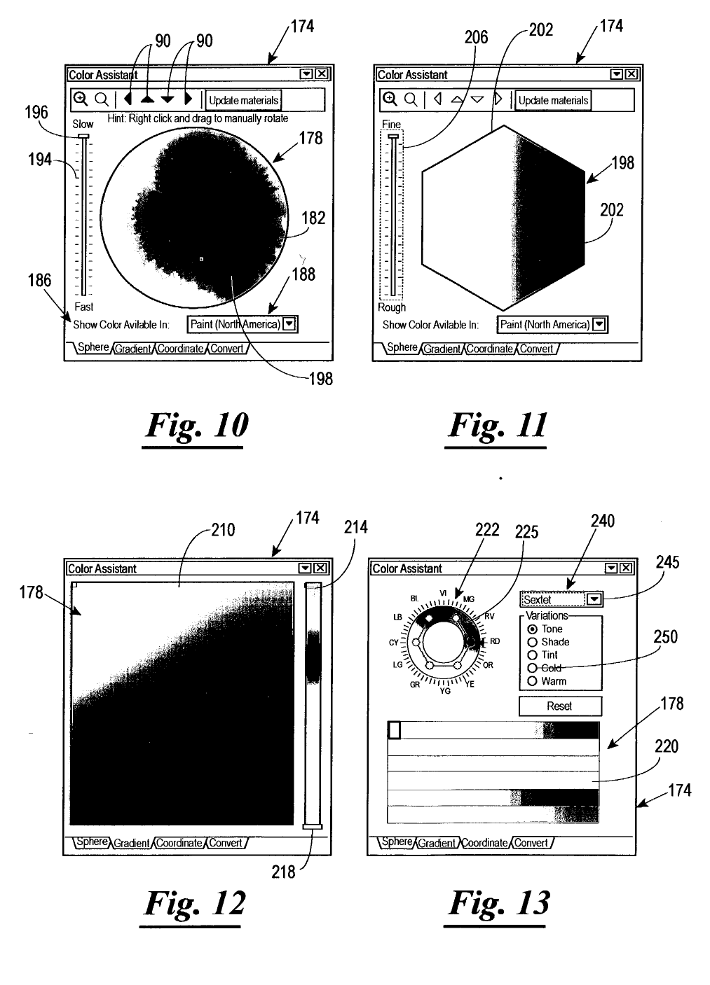

Once the consumer 20 has access to or has created a smart image file, the consumer 20 then utilizes the Preview sub-menu 112, and at least one color selector 174 (see FIGS. 10-12) within the specifier program 56, to change the color appearance of the color areas 144 within the image 140.

As shown in FIG. 9, the image 140 with the color areas 144 is displayed in the Preview sub-menu 136. This allows the consumer 20 to specify a color for each of the color areas 144. Once the color is specified for each color area 144, the image 140 is reproduced with the selected color in the color area 144. This coloring of the image 140 provides the consumer 20 with a pictorial indication of how the color area 144 will look in the desired color 32 so that the consumer 20 can make a determination on whether to obtain a colorable product, such as for example paint, having the desired color 32 for the purpose of using the colorable product in a project, such as for example painting the background wall area of a house.

Further, an original 170 of the image 140, one without the color areas 144, can also be displayed so that the image 140 and any changes within the color areas 144 of the image 140 can be readily seen and compared to the original 170.

The consumer 20 can specify the color in the color areas 144 of the image 140 by utilizing at least one color selector 174 within the specifier program 56 to provide information used by the specifier program 56 to alter RGB values assigned to pixels within the color areas 144 of the image 140 thereby changing the color appearance of the color areas 144 of the image 140. The color selector 174 can be implemented by at least one of providing the consumer 20 with a database of selectable colors 178 from which the consumer 20 can specify a color, or by querying input indicative of a color from the consumer 20. The database of selectable colors 178 can be represented in at least one of alphanumerical or pictorial form, wherein the alphanumeric or pictures are indicative of a color, and in at least one of one-dimensional, two-dimensional, or three-dimensional form. When the database of selectable colors 178 is represented in alphanumeric form, the database may be composed of a set of alphanumeric characters that are indicative of a color by representing color space information, such as for example, but not by way of limitation, in the form of alphanumeric RGB values or in the form of encoded data, such as the color code 34.

For example, as shown in FIG. 10, in one preferred embodiment, the color selector 174 displays the database of selectable colors 178 as a three-dimensional representation 182. The three-dimensional representation 182 can be a shape, such as a sphere. Though the three-dimensional representation 182 is shown in FIG. 10 as being spherical in shape, it should be understood that the three-dimensional representation 182 can be any three-dimensional shape.

The selectable colors displayed within the three-dimensional representation 182 are dependant on input information indicative of a specifiable colorable product which is queried from and specified by the consumer 20 by utilizing a Show Colors Available In field 186 provided in the color selector 174. The field 186 includes a list of a plurality of colorable products 188, such as paint (North American, European, Asian, etc.), grout, cement, or the like. This allows the selectable colors displayed in the three-dimensional representation 182 to be a function of pre-determined colorants used for coloring the colorable product.

The term “colorant” as used herein refers to anything that influences the color of a material, whether the color is visible or non-visible to a human. Common examples of a colorant are a pigment, a dye and combinations thereof. An example of a colorant which is non-visible to a human is a dye that fluoresces under ultraviolet light and in this instance, such dye is non-visible to a human under normal lighting conditions, but is visible to a human when the dye is exposed to ultraviolet light.

The consumer 20 can select a color displayed within the three-dimensional representation 182 by utilizing the input device 54, such as the mouse 66. The color appearance of a selected one of the color areas 144 within the image 140 is then changed to exhibit the desired color 32 as well as the shading, highlighting, and texture characteristics as described in conjunction with FIGS. 37a and 37b.

The three-dimensional representation 182 of selectable colors can be created for each specifiable colorable product so as to provide a representative of the gamut of colors obtainable with the colorant set for the specifiable colorable product. In one preferred embodiment, the selectable colors displayed in the three-dimensional representation 182 are colors representative of a selective color family, where a “color family” includes colors contained within a predefined range in the visual electromagnetic color spectrum. By displaying the representatives of selective color families, the three-dimensional representation 182 displays a more diverse gamut of colors obtainable within the limited pixel capacity of the three-dimensional representation 182, and by including selective color families, disproportionate representation of colors caused by the colorant set being skewed toward one primary base color is avoided.

In this embodiment, a database of possible color combinations for the colorant set of the colorable product is constructed by doing a permutation of the colors of the colorant set. The result of the permutation is sorted into color families. _This sorting is performed by converting each resulting color into HSB space (using methods well known in the art) and ordering the resulting HSB colors in a two dimensional grid in which one axis represents the H channel and the other represents the S channel while holding B constant at some predefined average value of B for the family. The axes of the grid increase from the minimum values observed to the maximum values observed in the resulting H and S channels respectively. A representative color of each color family is selected by finding the geometric centroid of the grid, of the resulting colors in a given family. Such a geometric centroid represents the average color value of the resulting family.

The RGB value for each of the representative colors is determined and is placed in a two-dimensional array in a predetermined manner wherein each RGB value is arranged in the array according to its RGB value relative to the other representative colors. Generally, the representative colors are arranged according to hue. In one preferred embodiment, the two-dimensional array is a 256×256 array so that up to 65,536 representative colors may be placed into the array. The two-dimensional array is then mapped to a three-dimensional representation 182 whereby the three-dimensional representation 182 displays the representative colors in the two-dimensional array. Mapping of the two-dimensional array to a three-dimensional bitmap image can be performed using any texture mapping tool, such as Microsoft Windows DirectX and OpenGL®.

The three-dimensional representation 182, in one preferred embodiment, is a multi-dimensional, geometric, spherical, visual color space model, manipulatable with three degrees of freedom, in real-time, for the identification and selection of specific individual colors, from a dynamic, context-sensitive, (potentially non-linear) sub-gamut from within the visual spectrum.

In order to ensure that all portions of the three-dimensional representation 182 can be viewed by the consumer 20, the three-dimensional representation 182 can be rotatable or movable, such that the consumer 20 can utilize the input device 54, such as the mouse 66, to rotate the three-dimensional representation 182. Further, the speed and direction of rotation can be determined by the manual use of the input device 54, or can be automatically determined by the use of the input device 54 in conjunction with a plurality of direction buttons 190, wherein the direction information is set by selecting one of the direction buttons 190, and a speed slider 194, wherein the speed is set by adjusting the position of an indicator 196 on the speed slider 194. Other methods of manually and automatically rotating the three-dimensional representation 182 will be apparent to one skilled in the art.

Further, the color selector 174 can enlarge a specified portion 198 of the three-dimensional representation 182 (FIG. 11). The enlarged portion 198 can be displayed in two-dimensional form, such as shown in FIG. 11. The enlarged portion 198 comprises a plurality of color regions 202 having different RGB values assigned to the pixels within the color regions 202 wherein the colors within the color regions 202 can be more readily identified. Further, the size and number of the color regions 202 of the enlarged portion 198 can be varied by the consumer 20 by utilizing a scale slider 206. The consumer 20 can then select a color displayed within the color regions 202, thereby specifying the desired color 32 and the color appearance of the selected one of the color areas 144 within the image 140 is changed to exhibit the desired color 32.

In another embodiment, the database of selectable colors 178 can be displayed in pictorial form and in two-dimension form in a gradient representation 210, such as shown in FIG. 12, whereby a predefined range of colors are displayed to the consumer 20. The range of colors displayed can be dependent on a foundation color that the consumer 20 specifies by utilizing a color gradient slider 214 having a color gradient indicator 218 to place the location of color gradient indicator 218 on the color gradient slider 214 so as to indicate a foundation color. Then the gradient representation 210 displays a predefined range of selectable colors that correspond to the foundation color indicated by the color gradient indicator 218 on the color gradient slider 214, wherein the predefined range of selectable colors includes the color of the foundation color and colors within an increasing and decreasing range of hue and an increasing and decreasing range of brightness from the color of the foundation color. The process of determining a gradient for a color is well known in the art. The consumer 20 can then select a color displayed within the gradient representation 210 to indicate to the specifier program 56 that a color has been specified and the color appearance of one or more color areas 144 within the image 140 can be changed to exhibit the desired color 32.

In another embodiment, the database of selectable colors 178 can be displayed in pictorial form and in two-dimension form in a color coordinates palette 220, such as shown in FIG. 13, whereby one or more coordinated colors are displayed to the consumer 20. The consumer 20 can then select coordinated colors for the color areas 144 to provide a coordinated appearance. In one preferred embodiment, the color coordinates palette 220 is color coordinated by utilizing a color wheel model 222. The color wheel model 222 can be used to specify a primary color on the color wheel model 222 and send information to the specifier program 56 which the specifier program 56 will utilize to determine a plurality of coordinating colors for the primary color. The specifier program 56 further indicates the plurality of coordinating colors on the color wheel model 222 and displays the specified primary color and the plurality of coordinating colors in the color coordinates palette 220.

The color coordinates palette 220 can also display colors within a predefined range of increasing and decreasing brightness from the specified primary color and the plurality of coordinating colors. The consumer 20 can select a color displayed within the color coordinates palette 220. Further, the number of coordinating colors to be determined, indicated, and displayed by the specifier program 56 can also be set by the consumer 20 by utilizing a grouping field 240 and a panel stroke grouping scroll bar 245 which then causes a list of selectable groupings to be displayed for selection, such as by way of example but not limitation, single, analogous, complimentary, triangle, tetrad, pentad and sextet, all of which are known in the art. Further, coordinating variation qualities, such as tone, tint, shade, and cold and warm colors, can be used by the specifier program 56 in determining coordinating colors to be specified by the consumer 20 by utilizing a plurality of variations radial buttons 250 (only one being numbered for purposes of clarity).

Generally, the initial determination of the coordinate colors by the specifier program 56 is based on an equilateral relationship between a number of specified points on the color wheel model 222, wherein the number of specified points corresponds to the selectable grouping specified. Each coordinate color is determined by its corresponding relationship from the specified primary color 225 on the color wheel model 222. Further, after the initial determination, the relationship between the primary color and the coordinate colors can be changed by the consumer 20 by utilizing the color wheel model 222 to specify the relationship between the specified points on the color wheel model 222. As a result, the coordinate colors will be redetermined by the specifier program 56 and displayed in the color coordinates palette 220.

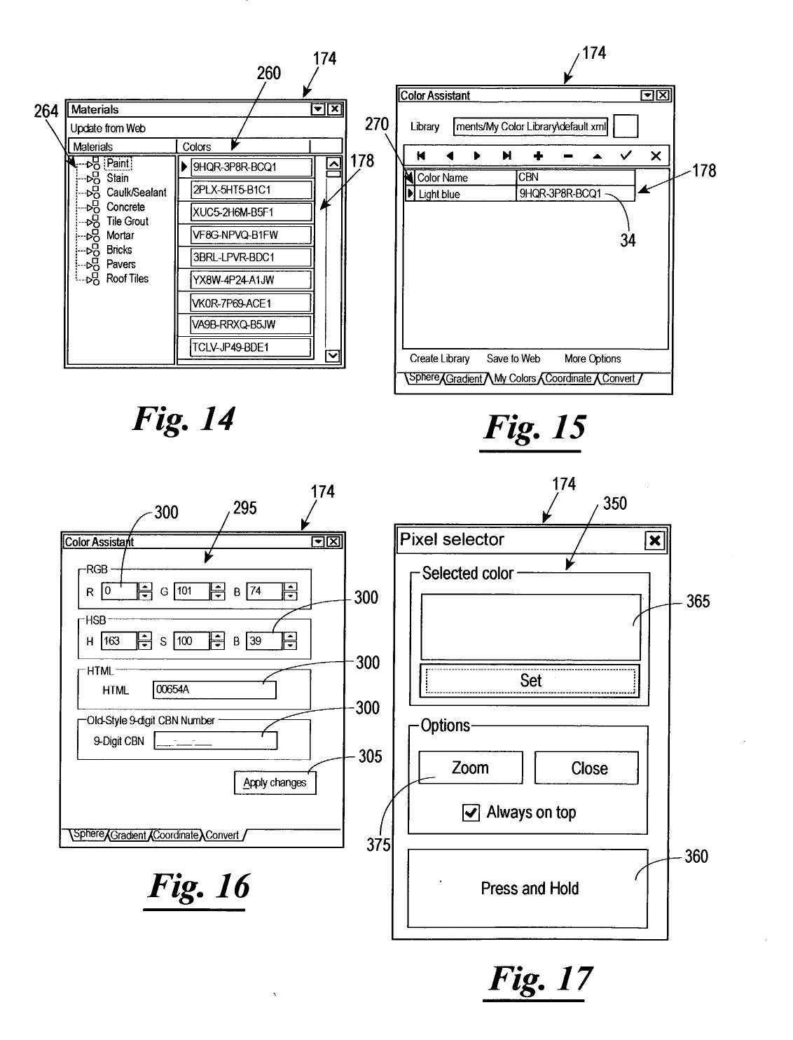

In another embodiment, the database of selectable colors 178 can be displayed in pictorial and/or alphanumerical form and in two-dimension form in a color chart 260, such as shown in FIG. 14, whereby a plurality of selectable colors for a plurality of colorable products, such as by way of example but not limitation, paint, stain, caulk, sealant, concrete, grout, mortar, bricks, pavers, frosting (and other colorable food items), cosmetics, and roof tiles, are displayed to the consumer 20. In such an embodiment, the selectable colors for the plurality of colorable products displayed can be existing colors for the colorable products, i.e. color that each respective industry have predefined and currently make in bulk commercial form. The consumer 20 can utilize the input device 54, such as the mouse 66, to specify a colorable product from a product listing 264, whereby the selectable colors for the specified colorable product 33 will be displayed in the color chart 260. The consumer 20 can then select a color within the color chart 260 to indicate to the specifier program 56 that a color has been specified and the color appearance of one or more color areas 144 within the image 140 can be changed to exhibit the desired color 32.

In another embodiment, the database of selectable colors 178 can be displayed in pictorial and/or alphanumerical form and in one-dimensional form in a user color list 270, such as shown in FIG. 15, wherein colors and color information, such as the color code 34, are displayed to the consumer 20. The color displayed in the user color list 270 are colors generated from color information saved by the consumer 20 in a plurality of library files on the computer 50 which are accessible by the specifier program 56. The library files can be at least one of created, downloaded, and exported files by the consumer 20. The downloading and exporting of the library files may also be done over the Internet such that remote consumers 20 may share color libraries with one another. The user color list 270 can further allow the consumer 20 to organize the database of selectable colors 178 by adding, deleting, editing, saving, and traversing the pictorial and/or alphanumerical forms in the user color list 270. The user color list 270 may further provide for printing of the pictorial and/or alphanumerical forms of database of selectable colors 178.

The color selector 174 can further be implemented by querying input indicative of a color from the consumer 20. In one preferred embodiment, such as shown in FIG. 16, the color selector 174 includes a convert panel 295 whereby the consumer 20 is queried for input that is indicative of a color the consumer 20 wants to select. Input indicative of a color can be color space information relating to the desired color 32. For example, the input indicative of a color can be the alphanumerical value of the desired color 32 in a color space, such as by way of example but not limitation, the RGB color space value, the HSB color space value, or the HTML color space value. The consumer 20 can input alphanumeric values into color input fields 300 (only four being numbered for purposes of clarity) and then initiate an Apply Changes button 305 to indicate to the specifier program 56 that a color has been specified.

The color selector 174 can also be implemented by allowing the consumer 20 to specify a pixel on the monitor 52 whereby the color information, such as the RGB value, of the specified pixel is sent to and received by the specifier program 56 to indicate the desired color 32, wherein the desired color 32 will be the color of the pixel. In one preferred embodiment, such as shown in FIG. 17, the color selector 174 includes a pixel specifier 350 having a press-and-hold button 360 which can be used in conjunction with the input device 54, such as the mouse 66, by the consumer 20 to indicate to the specifier program 56 that a pixel of an image displayed anywhere on the monitor has been specified. The color of the specified pixel can be displayed to the consumer 20 in a selected color display 365 so that the color can be readily viewable by the consumer 20. Further, the selected color display 365 can also be used to display any intermediate pixels that are traversed by the mouse 66 before a pixel is specified by the consumer 20 so as to aid the consumer 20 in specifying a specific pixel having the color desired to be selected.

Once a pixel has been specified, the color appearance of one or more color areas 144 within the image 140 is changed to exhibit the desired color 32 of the specified pixel. Since the color selector 174 allows a color to be specified by specifying a pixel on the monitor 52, the consumer 20 can utilize the color selector 174 to specify a color from an image, such as a digital picture, displayed on the monitor 52. Further, the color selector 174 can further comprise a zoom button 375, wherein the consumer 20 can utilize the zoom button 375 to enable a zoom window (not shown) wherein the zoom window displays a magnified representative of the pixels generally around the pixel over which the mouse 66 is traversed so that the colors of the pixels generally around the pixel over which the mouse 66 is traversed can be more readily identified so as to aid the consumer 20 in specifying the pixel having the color desired to be selected. The uses of zoom functions are well known to those of ordinary skill in the art.

Once the consumer 20 has selected a color using the color selector 174 and has indicated to the specifier program 56 that a color has been specified, the color appearance of one or more color areas 144 within the image 140 are changed to exhibit the desired color 32.

Once a color has been specified, the specifier program 56 further displays and provides to the consumer 20 the color code 34 corresponding to the desired color 32. For example, as shown in FIG. 9, the color code 34 is displayed in a CBN field 380, which corresponds to the desired color 32 displayed in the adjacent color field 390. The color code 34 comprises encoded data indicative of the desired color 32. In one preferred embodiment, the color code 34 is a set of alphanumeric characters from which color information of the desired color 32 can be obtained, once decoded. The color specification system 30 generates the color code 34 by manipulating color information of the desired color 32, such as color space values or spectral frequency values. Common examples of color space values well known in the art include RGB values, HTML values, BradFord-RGB values, CMYK values, LAB values, HSB values HSV values, SCF values, XYZ values, and LUV values.

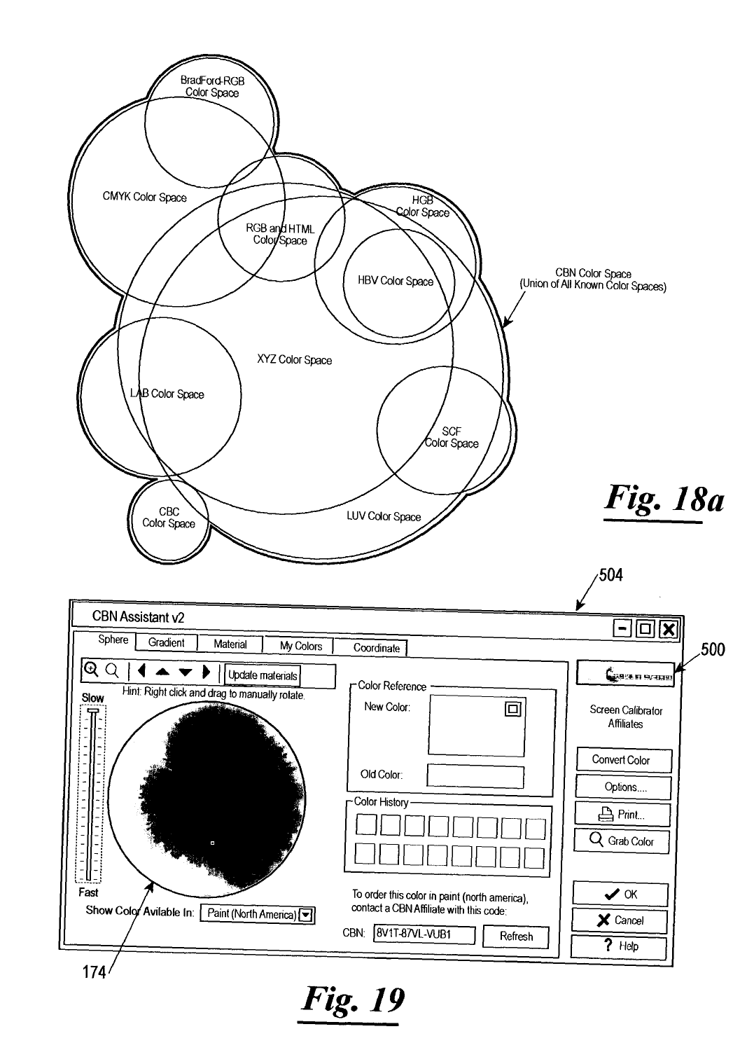

Referring now to FIG. 18, shown therein is a graphical representation of the various color spaces well known in the art some of which being listed hereinabove. Note that the representation of the various color spaces is intended as a visualization aid only and is not a literal representation of the unions and intersections of the color spaces therein since, generally, color spaces exist in multi-dimensional spaces and are mathematically non-linear. The span of the color codes 34 capable of being generated using the present invention encompasses each of these color spaces so that the color specification system 30 can use input data of color space values in any of these color spaces to generate the color code 34. This allows for the conversion of the color space values for a color found within one or more of the various color spaces into one standardized value represented by the color code 34 corresponding to that color across any material and/or substrate that is capable of being colorized.

In order to generate the color code 34 for a color, color information of the color is converted relative to a host color space to form the standardized value represented by the color code 34. Although the host color space will be described herein as LUV space, it should be understood that the present invention is not limited to the host color space being LUV space. The host color space can be LUV space, LAB space or another color space. The standardized value represented by the color code 34 is then manipulated through a reversible encryption sequence. In general, the manipulation of the standardized value represented by the color code 34 can be performed using any reversible encryption sequence wherein no loss of information occurs during the sequence or during the inverse of the sequence. While preferred embodiments for the encryption sequence are discussed herein below, by way of example, one of ordinary skill in the art will recognize that other encryption sequences and techniques could be used so long as substantially the entire color information for the color is preserved during the encryption and decryption sequences—i.e. the standardized value represented by the color code 34 is maintained.

In one preferred embodiment, as shown in FIG. 18b, the color code 34 for a color is generated by converting the inputted color information relative to LUV color space (i.e., the host color space), regardless of whether the color falls inside the normal range of LUV space or not, and then applying an encryption sequence to the inputted color information for the color. That is, in a step 400, the inputted color information is converted from XYZ, RGB or other color space relative to LUV color space. The algorithms for converting color information relative to LUV color space are well known in the art. The normal conversion process for converting colors which are not valid inside LUV space would include, as a final step, finding the closest valid LUV color to the point in space represented by the converted color that is outside the valid space for LUV. It is important to note this last step is not performed—thus the conversion is “relative” to LUV space and not “into” LUV space thus allowing representations of colors in ANY space whether or not they are coincident with a given point (color) inside valid LUV space. For example, if the color information for the color is in the XYZ color space, well known conversion formulas for converting XYZ values relative to LUV values can be utilized.

As an example, the conversion of LUV can be visualized as a table. The top of the table is what would be considered “valid LUV space” values. Thus, the position of items resting on the table top can be specifically denoted with respect to being on the table top. Items that are positioned away from the table top (such as on the floor next to the table) can also be described as having a position relative to the table top. In the same manner, any input color value from RGB, CMYK, etc. can be converted and described relative to LUV color space.

The L, U, and V values provided by the conversion range from −238 to +762, where valid LUV space is typically (0<=L<=100, −134<=U<=220, −140<=V<=122) which can be, as described above, either valid or invalid values in the LUV color space. The encryption sequence then branches to a step 402 where each of the L, U and V color space values are normalized by adding +238 to such values. The encryption sequence then branches to a step 404, where for each L, U, and V value; the value is separated into an integer component (exponent) and a decimal component (mantissa). The decimal component is then rounded to a desired precision, such as for example, a precision of three decimal places. The rounding of the decimal component causes a permanent loss of information. Thus, the desired precision can vary widely depending on the desired accuracy of the system designer. For example, the decimal component can be rounded to any desired decimal place, such as 1-100 decimal places. The encryption sequence then branches to a step 406 where each of the exponent and decimal components are converted to binary strings. The encryption sequence then branches to a step 408, where the L value integer, the L value decimal, the U value integer, the U value decimal, the V value integer, and the V value decimal are each then converted to a 10-bit binary representation (in step 408) and concatenated into a 60-bit array (in a step 410).

The encryption sequence then branches to a step 412, where the 60-bit array is processed in a symmetric key encryption scheme with a key length of 672-bits, (21 32-bit values). In the step 412, the concatenated 60-bit string is exclusive Or'd with a key K via the formula shown in step 412 of FIG. 18b. The exclusive Or is performed three times, once for each 20 bits in the 60-bit string. The result of step 412 is then stirred with a sequence S to further mix the bits in the 60-bit string as indicated by a step 414. The encryption sequence then branches to a step 416 where the stirred bit string is then exclusive Or'd with the key K via the formula shown in FIG. 18b. In step 416, the exclusive Or is performed three times, once for each 20 bits in the 60-bit string.

The key K and the sequence S can be any array that is adopted and standardized to fit the encryption scheme. One of ordinary skill in the art, given the present specification, would understand that any type of key K or sequence S could be used. As by way of one example, but not limiting thereto, the key K could be represented as 21 values of 20 bits each (Max), such as:

| Array[0..20] of long Word = ( | | | |
|---|---|---|---|
| $F4A35, | $E651E, | $D5CA3, | |
| $B5C97, | $C20D0, | $A457F, | |
| $91DE7, | $83EB5, | $73975, | |
| $63AE4, | $56D55, | $47C75, | |
| $F752F, | $E6250, | $D1287, | |
| $C7A8D, | $D72B5, | $A49FD, | |
| $05F85, | $70CA7, | $928CF | ) |

As by way of one example, but not limiting thereto, the sequence S could be represented as a diffusion sequence to help with encryption by way of a non-ordered set of 1 through 60 inclusive, such as:

Array[1..60] of byte = (

| | | | | | | | | | | |
|---|---|---|---|---|---|---|---|---|---|---|
| 14, | 48, | 22, | 1, | 28, | 51, | 15, | 29, | 6, | 56, | |
| 3, | 34, | 24, | 12, | 35, | 32, | 38, | 21, | 59, | 41, | |
| 20, | 27, | 46, | 39, | 60, | 45, | 7, | 42, | 13, | 54, | |
| 11, | 44, | 37, | 19, | 2, | 50, | 5, | 57, | 8, | 47, | |
| 30, | 23, | 17, | 53, | 49, | 33, | 43, | 16, | 25, | 55, | |
| 40, | 26, | 18, | 31, | 9, | 52, | 36, | 10, | 58, | 4 | ) |

Also, as shown in FIG. 18b, in the step 414, the bits produced in the step 412 can be stirred with sequence S a predetermined number of times, for example, but not by way of limitation, the bits produced in the step 412 can be stirred with sequence S five times.

The encryption sequence then branches to a step 418, where the modulated 60-bit array is separated into twelve 5-bit segments. The twelve 5-bit segments are then converted from its binary format into a corresponding color code character value. In one preferred embodiment, the color code character value is a value within the group of alphanumeric characters of 0-9, A-H, J-N, P-R, T-Y, and each value corresponds to a unique binary value found in the range of binary values for 0-31. The standard alphanumeric values of I, O, S, and Z are not included in the color code character value set to eliminate visual confusion with the alphanumeric characters 1, 0, 5, and 2, respectively. The encryption sequence then branches to a step 420, where each color code character for the 5-bit segments are concatenated into a string so as to collectively form the color code 34 for the color. Further, use of a visual separator in the concatenated string, such as for example, a hyphen, can be used so as to make the color code 34 more easily readable to the consumer 20 and/or product provider 25.

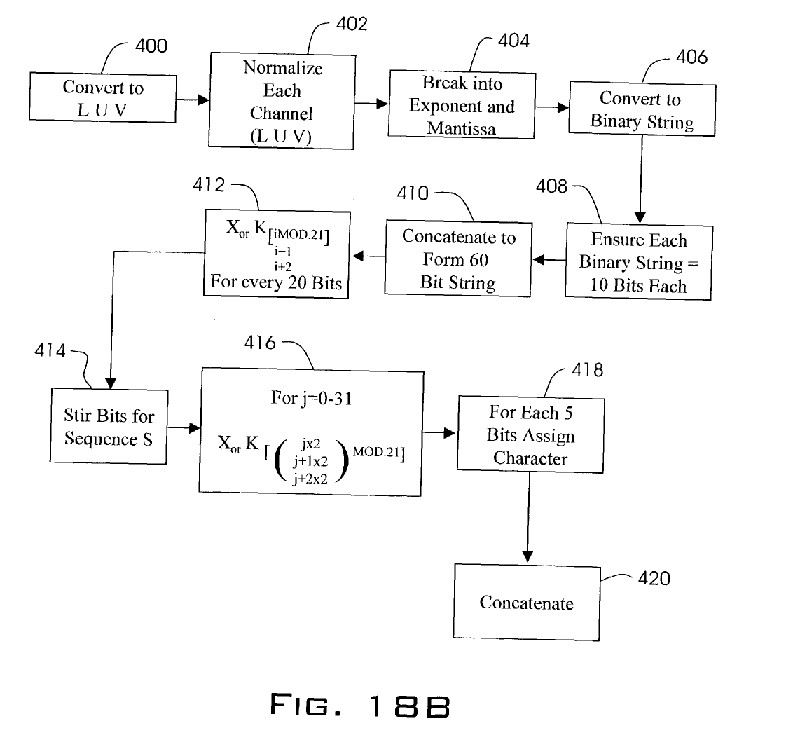

In another embodiment, the specifier program 56 is implemented as plug-in software which requires third party software to operate. In such an embodiment, the specifier program 56 can provide the consumer 20 with a specifier user interface 104 (FIG. 19). For example, and as shown in FIG. 19, the specifier user interface 104 includes an assistant main menu 500 for an assistant user interface 504, constructed in accordance with the present invention. The specifier program 56 comprising the plug-in software operates essentially the same as the specifier program 56 comprising the stand-alone software, described above, except that the specifier program 56 comprising the plug-in software is adapted for incorporation into a parent application.

For example, the parent application can be design software, such as Adobe Photoshop®, CorelDraw®, AutoDesk®, or AutoCad®. The specifier program 56 comprising the plug-in software can be used to alter, enhance, or extend the operation of the parent application. For example, the specifier program 56 comprising the plug-in software can be constructed so as to allow the consumer 20 to create a project design and layout using an existing design software application, and then within the project design and layout, specify a portion of the project and a color that is to be used in that portion of the project by utilizing various user tools provided by the specifier program 56 via the assistant user interface 504. The assistant user interface 504 provides the same user tools as the specifier user interface 104 and in the same manner as the specifier user interface 104, including the color selector 174, to aid the consumer 20 in specifying a color.

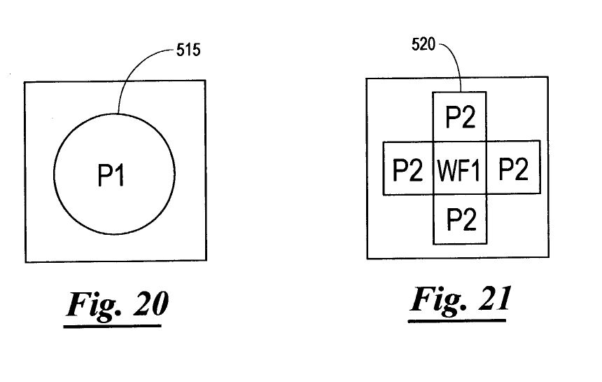

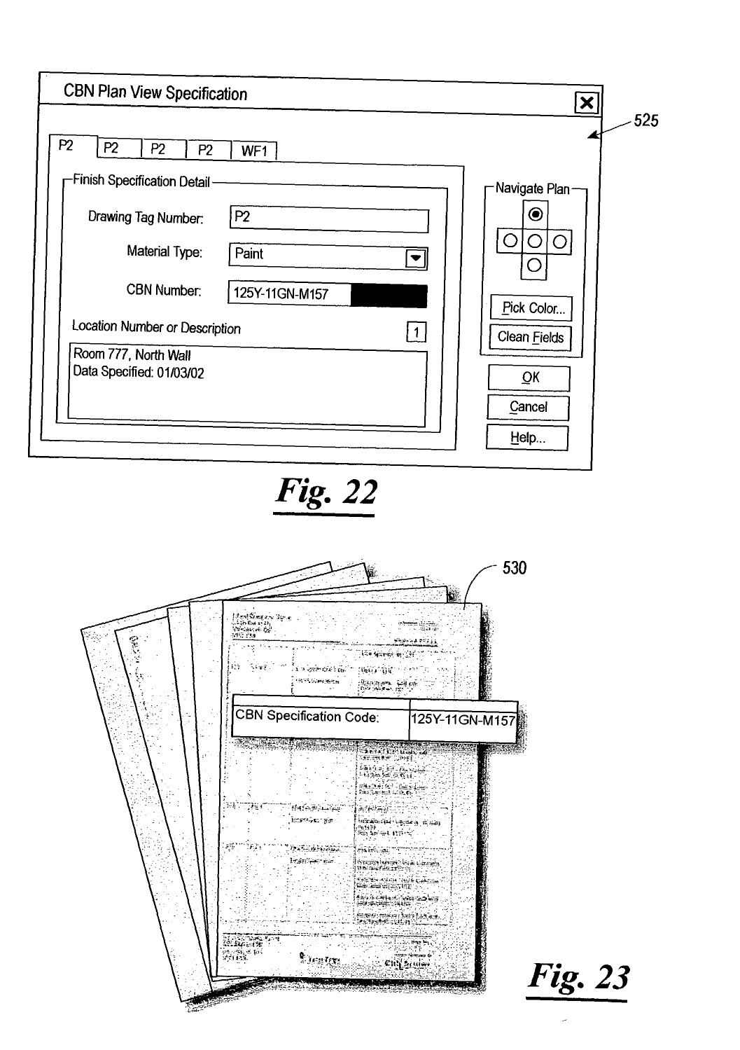

The specifier program 56 comprising the plug-in software can be further constructed to allow the consumer 20 to: (1) create labels in the project within the existing design software, such as for example, a wall label 515, as shown in FIG. 20, or a room label 520, as shown in FIG. 21; (2) store project information on the computer 50, for example, by using a plan specification window 525, as shown in FIG. 22; (3) link stored project information to corresponding labels; and (4) create and print a report of project information, such as for example, a color specification report 530, shown in FIG. 23. Project information can include details of the project, such as (1) the name of the project, (2) the name of the consumer 20, (3) the name of a client, (4) the color code 34 for the color specified for specific portions of the project, (5) the location of the specific portions within the project, (6) the quantity of the specified colorable product 33 that will be utilized in each specific portion of the project, and (7) the name of the product provider 25 from which each specified colorable product 33 can be obtained.

Referring again to FIG. 1, once the consumer 20 inputs color information into the color specification system 30 to specify a color and receives the color code 34 corresponding to the desired color 32 generated and outputted by the color specification system 30, the color specification system 30 directs the consumer 20 to communicate the color code 34 to one or more of the product providers 25 within the affiliation 10 who has the ability to (1) convert the color code 34 into a formula for making the specified colorable product 33 having the desired color 32; (2) make the specified colorable product 33; and (3) provide the specified colorable product 33 to the consumer 20. The consumer 20 will also need to communicate the quantity or amount of the colorable product 33 to be colored to the product provider 25 as well.

The consumer 20 can communicate the color code 34 and the desired quantity of the colorable product 33 through any communication medium, such as oral or written communication. For example, the consumer 20 can have a telephone conversation with an agent of the product provider 25, send a written document via the mail, fax, or email to the orders department of the product provider 25, or drive to a local product provider 25, such as a local home improvement store, and give direct physical delivery of oral or written communication to an agent of the product provider 25. For example, the consumer 20 can provide a computer printout of the color code 34 to the product provider 25.

Once the product provider 25 receives the color code 34 and the quantity from the consumer 20, the product provider 25 inputs the color code 34 and quantity information into the formulation system 31. The formulation system 31 then generates and provides to the product provider 25 the real-world volumetric, or if preferred by-weight, formula 42 for making the specified colorable product 33 having the desired color 32. Once the formulation system 31 provides the product provider 25 with the formula 42, the product provider 25 utilizes the formula 42 in making the specified colorable product 33 having the desired color 32 and then provides the specified colorable product 33 having the desired color 32 to the consumer 20. Generally, the consumer 20 will give some consideration to the product provider 25 in return for the specified colorable product 33 having the desired color 32. The formulation system 31 can be provided with a default quantity, or automatically break the total quantity into smaller quantities. For example, if the consumer 20 desires 5 gallons of paint, the formulation system 31 can produce the formula 42 for a one-gallon can of paint and then the product provider 25 would mix 5 one-gallon cans of paint.

In one preferred embodiment, in order to generate the formula 42, the formulation system 31 utilizes information from the color code 34 and the quantity information, in conjunction with a database of predetermined colorant parameters to generate the formula 42. The colorant parameters can be absorption coefficients K and scattering coefficients S for a plurality of pigments, filler, and bases corresponding to colorants in predefined colorant sets, with each set corresponding to one or more colorable product.

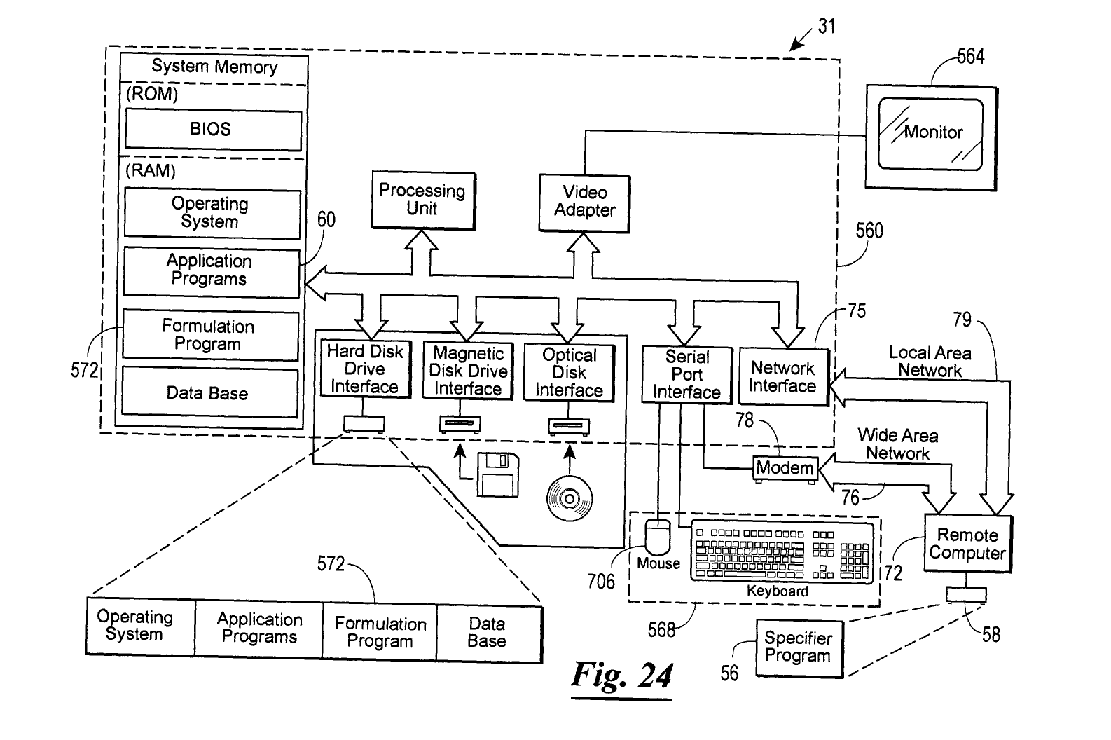

As shown in FIG. 24, in one preferred embodiment, the formulation system 31 includes a computer 560, a monitor 564, an input device 568, and a formulation program 572. A suitable computing environment in which the invention may be implemented is essentially the same as the computing environment used for the color specification system 30, as described in detail above, therefore no further discussion is deemed necessary.

In general, the formulation program 572 provides a user interface which allows the product provider 25 to input the color code 34 and quantity information into the formulation program 572 by using the input device 568 and the computer 560, and then outputs the formula 42, so as to provide the product provider 25 with a real-world volumetric formula, or a by-weight formula, for making the specified colorable product 33 having the desired color 32. The formulation program 572 generally outputs the formula 42 to the monitor 564, but can also output the formula 42 to an output device, such as a printer, or to another program, such as for example, a colorant dispenser control program (not shown)

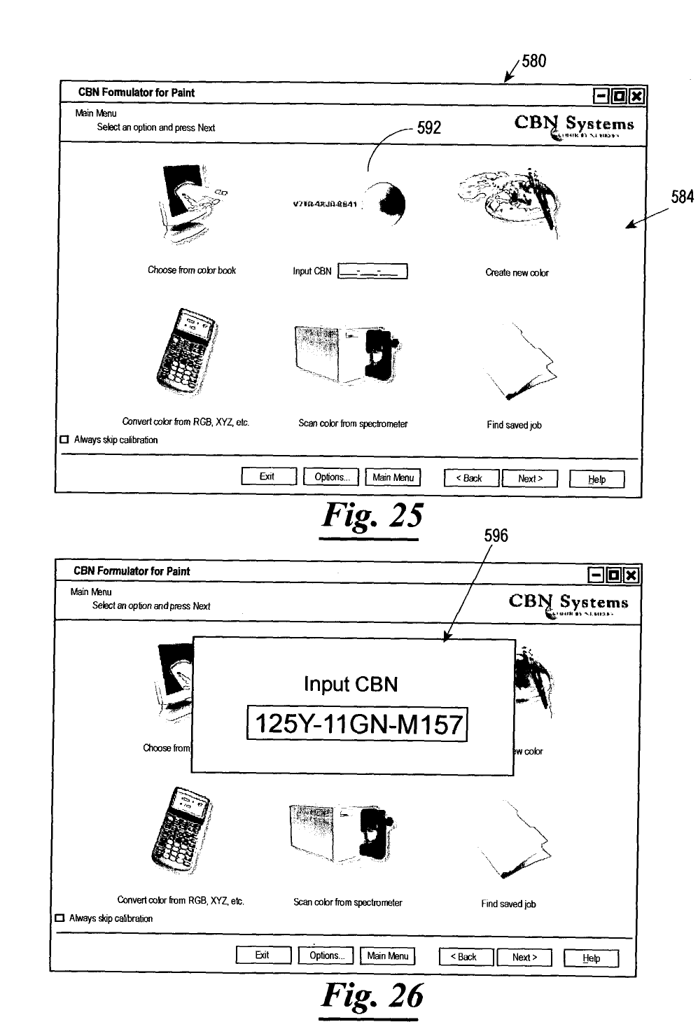

As shown in FIG. 25, in one preferred embodiment, the formulation program 572 provides the product provider 25 with a formulator user interface 580. The formulator user interface 580 includes a formulator main menu 584, constructed in accordance with the present invention. The formulator main menu 584 includes a link for selecting an Input CBN sub-menu 592, whereby once the product provider 25 selects the Input CBN sub-menu 592, the formulation program 572 represents a set of menu-driven questions directed to the product provider 25, via the monitor 564, prompting the product provider 25 to input: (1) the color code 34 into an Input CBN field 596, as shown in FIG. 26; (2) the type of colorable product 33 that is to be colored which is predetermined by the particular release of the formulation program 572 with each release being specific to a specific material type (although one of ordinary skill in the art would recognize and appreciate that one “master” formulation program 572 may be provided by the affiliation 10 so as to be generic and encompass every material type or any number of subsets of material type such as construction materials, food items, decorative items, etc.); and (3) the quantity of the colorable product 33 that is to be colored into an Enter Quantity field 604 and the units of the quantity into a units field 608, as shown in FIG. 28.

Although the formulation program 572 is described herein as being specific to a specific material type, it must be reiterated (as outlined hereinabove) that the formulation program 572 can be programmed for multiple material types. In this instance, the formulation program 572 would permit selection by the user of one of the multiple material types.

Once the product provider 25 has inputted the color code 34 as well as the quantity and unit information of the colorable product 33, the formulation program 572 uses this information in sequencing through a main logic loop to generate the formula 42 that is capable of producing a color using colorant ratios. One of ordinary skill in the art would recognize that some of the before-mentioned information can be provided or can be assumed by the formulation program 572. For example, the formulation program 572 could ask for the quantity in terms of gallons. In this example, if a consumer 20 only wanted one quart, 0.25 would be entered into the Enter Quantity field 604.

The process of coloring the colorable product 33 is well known in the art, however, in general, colorable products are colored by adding a combination of colorants to a base material of the colorable product 33 via a dispensing system to form a desired color in the colorable product 33. By altering the amount of colorants that are added from each predefined colorant, numerous combinations are possible, and hence numerous color variations are possible for the colorable product 33. Industries using liquid color dispersion in the direct dispense or color pack methods, such as for example, paint, tile, grout, caulking, sealants, and stains, and industries using dry additive pigments, such as for example, concrete, brick and block, roof tiles and pavers, generally use a dispensing system that directly relates to the colorant set available in the industry. For example, when the colorable product 33 is paint, the dispensing system can be a manual or automatic dispenser obtainable from Hero Industries of Vancouver, British Columbia, Canada.

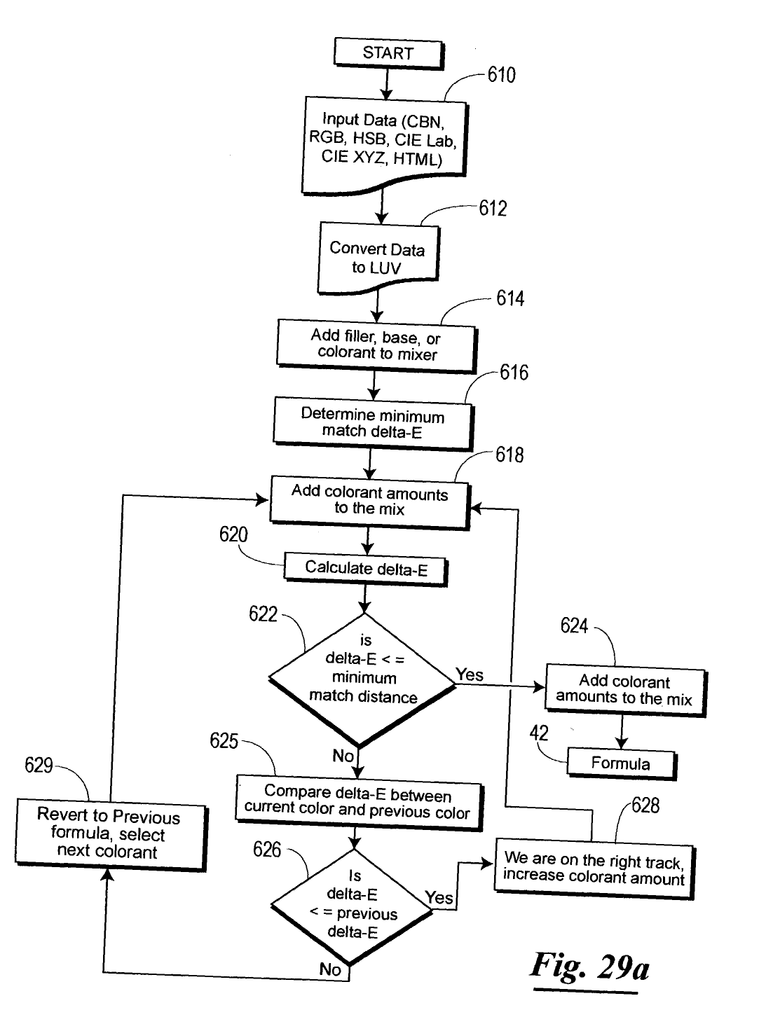

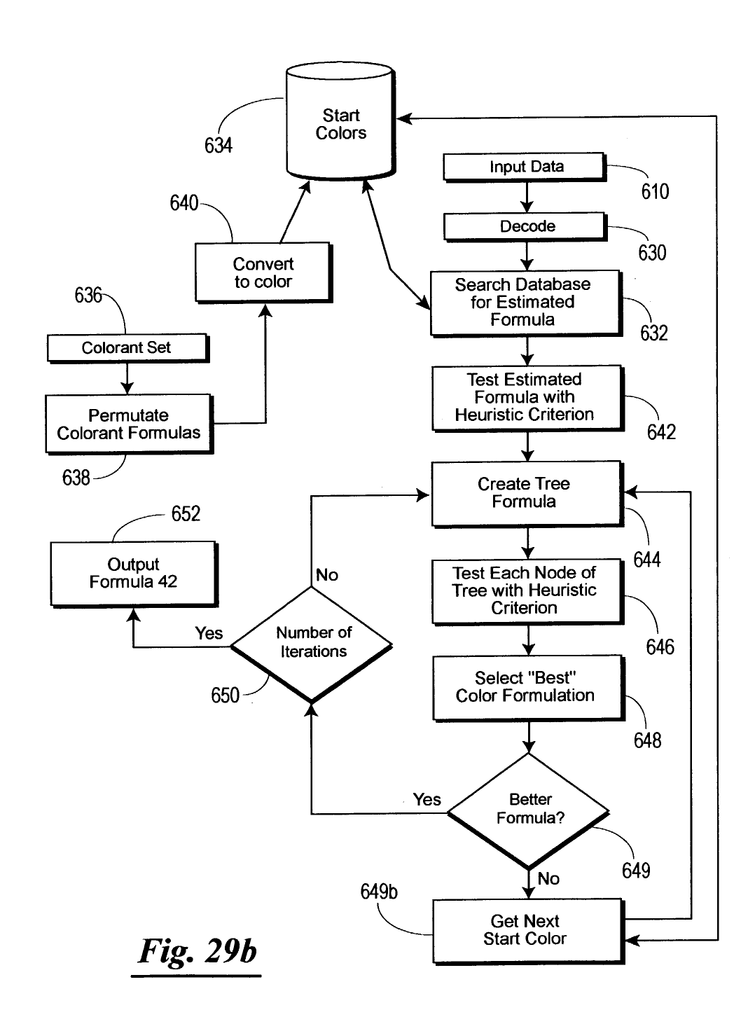

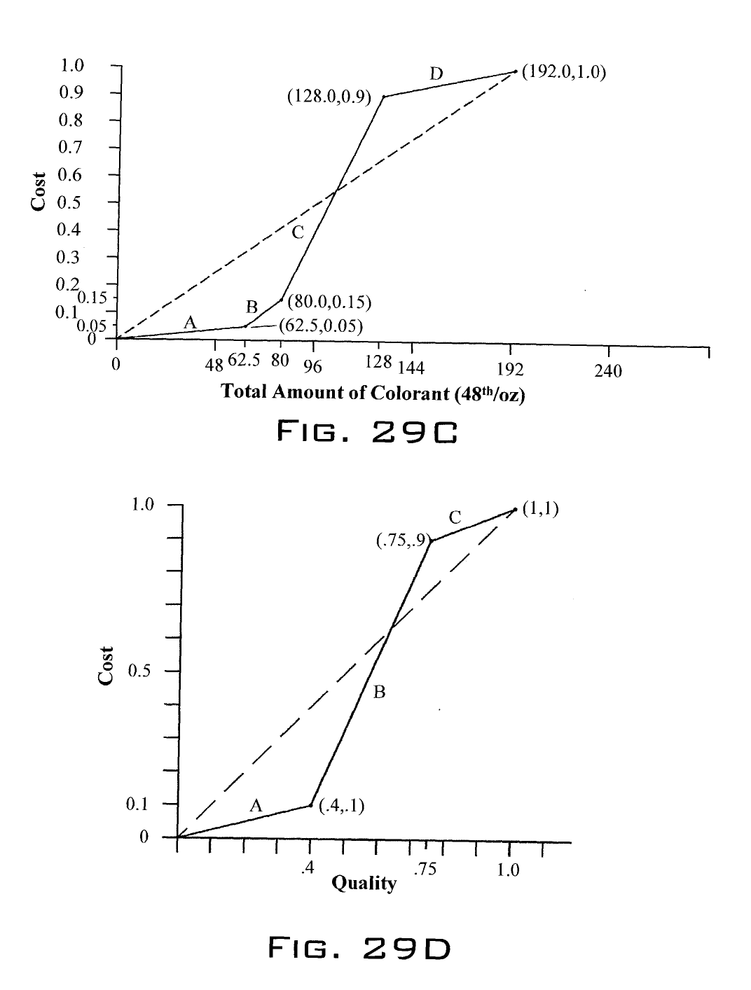

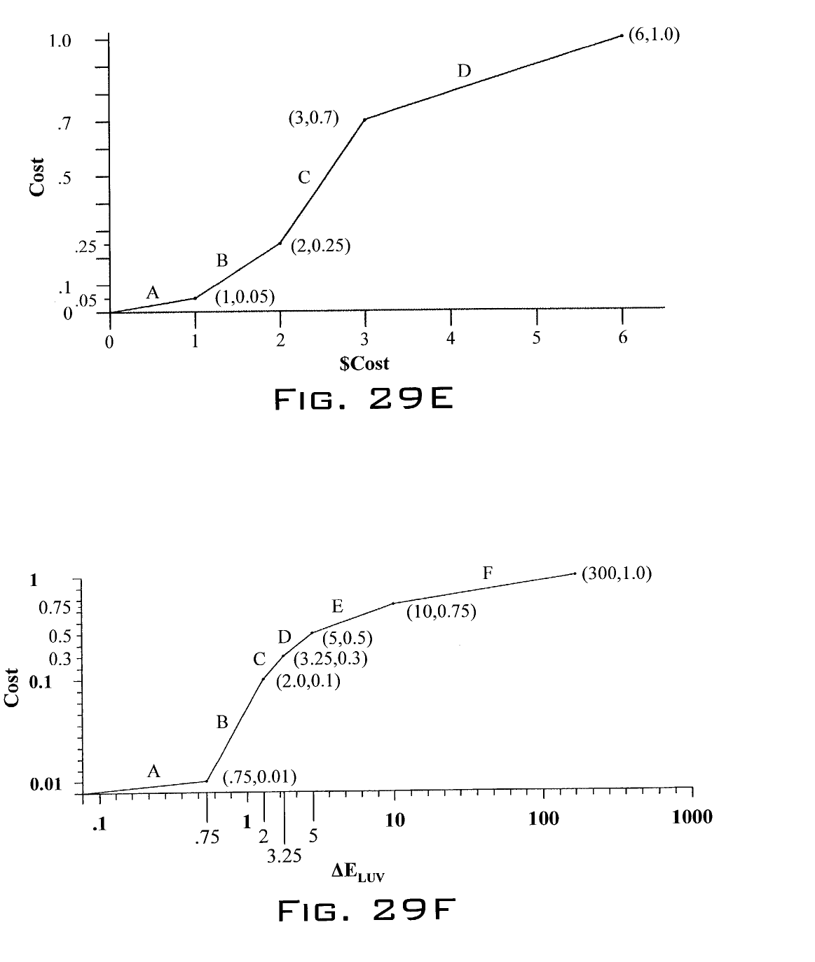

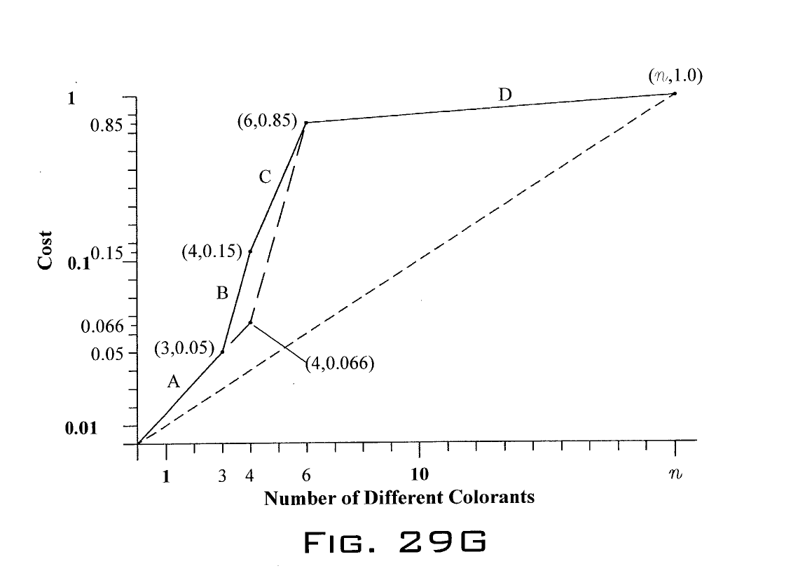

One embodiment of the main logic loop for generating the formula 42 is shown in FIG. 29a. The main logic loop uses predetermined colorant parameters, such as absorption coefficients K and scattering coefficients S to generate the formula 42. For each type of colorable product 33, the sequencing of the main logic loop is essentially the same, with the difference being the colorant set to be used and the corresponding absorption coefficients K and scattering coefficients S for the pigments, fillers, and bases corresponding to the colorant set.

Upon initiation, the main logic loop branches to a step 610. In the step 610, the color code 34 is inputted. In the step 610, other color information indicative of the desired color 32, such as color space values, e.g., RGB values or HTML values, or spectral frequency values, can be inputted into the formulation program 572 rather than the color code 34.

Once either the color code 34 or the color information is inputted into the formulation program 572, the formulation program 572 branches to a step 612. In the step 612, the color code 34 or color information is then converted into a format needed to perform color matching calculations. For example, when the formulation program 572 is adapted to perform Delta-E calculations, the color code 34 or color information is converted into LUV color space values or LAB color space values. Preferably, the color code 34 or color information is converted to LUV color space values. The color code 34 is decoded by manipulating the color code 35 using inverse operations of the encryption sequence used by the color specification system 30 in generating the color code 34, as discussed above, such that the color code 34 is converted back into the standardized value relative to the LUV color space values for the color.

The formulation program 572 then branches to a step 614 where predetermined colorant parameters, such as absorption coefficients K and scattering coefficients S of fillers, bases and/or pigments relating to the coloring of the colorable product 33 are loaded into the formulation program 572, which in one preferred embodiment will be used by the formulation program 572, in conjunction with formulas relating to the Kubelka-Munk theory, to formulate the formula 42 for the desired color 32.

In other words, the formulation program 572, in the step 614 generates an initial formula. The initial formula is determined as follows. Assuming that the base material is not transparent, K and S values indicative of a small amount, e.g., 1/48 oz., of the base material forms the initial formula. If the base material is transparent, K and S values indicative of a small amount, e.g., 1/48 oz. of one of the colorants in the colorant set forms the initial formula. Thus, the formulation program 572 generates an initial formula in the step 614 “on-the-fly” utilizing predetermined and standardized K and S values (based upon curves) for the colorant set, or base material used to formulate the desired color 32 for the colorable product 33.

The use of absorption coefficients K and scattering coefficients S in correlation with the Kubelka-Munk theory to model colorant mixing and determine expected colors is well known in the art. Therefore, no further discussion is deemed necessary to teach one skilled in the art to make and use the present invention. In addition, other ways of characterizing the colorants, bases or fillers may be used, as well as other ways of modeling colorant mixing to determine expected colors. Certain aspects of Kubelka-Munk theory are set forth hereinafter, however, for purpose of explanation, although it should not be regarded as exhaustive of the Kubelka-Munk theory or as being limiting to the explanatory detail hereinafter given.

Generally, there are three main steps in accumulating K and S data for a colorant set. For each non-white colorant in the set, multiple physical samples of the colorant are made, for example three samples are made. The samples are made using a substrate that will have minimal effect on the color of the colorant mix disposed thereon. One of the samples will have the colorant in pure form disposed thereon. The second sample will have the colorant mixed with a predetermined amount of white colorant disposed thereon. The third sample will contain the colorant mixed with a predetermined amount of black colorant disposed thereon.

For each sample, the reflectance values R is measured across the visible electromagnetic spectrum (λ=380 nm-780 nm) and recorded. The white colorant in the colorant set is used to determine the K and S values for the other colorants in the set, therefore it is treated separately. For each wavelength at which R was measured, a normalized corresponding R value is used to calculate \overline{ω}_{W}, the K/S value at a given wavelength λ. The accumulating of K and S data for a material, such as a colorant, base or filler is well known in the art using Kubelka-Munk theory. The following sets forth a discussion of one manner in which Kubelka-Munk theory can be used to generate the K and S data for a material, as well as to determine an estimated color.

There are three steps involved in accumulating K and S data for a Colorant Set. For each non-white colorant in the set, at least 23 physical samples should be made in a substrate that has little to no effect on the color, if possible. These will include: Pure Colorant, Colorant with White Mix, and Colorant with Black Mix. Once the samples are prepared, they can be measured for Reflectance (% R) values (See Table 2) across the Visible Spectrum (λ=380 nm-780 nm). These values are stored in simple two-dimensional arrays for easy retrieval.

The symbols to be discussed are set forth below.

K=Absorption curve

S=Scattering curve

λ=Lambda (wavelength in nanometers)

R=Reflectance (0-100%) at a given wavelength (λ)

\overline{ω}=Omega (K/S at a given wavelength)=(1−R)²/(2*R)

W=White Colorant

Since white will be used to determine the K, S curves for all other colorants, it will be treated separately. For each wavelength ( ) in its array the normalized Reflectance (0-1) is used to calculate:

\overline{ω}_{W}=K_{W}/S_{W}=(1−R)²/(2*R)

A starting point must be determined so S_{W}=1 for white and the other colorants are calculated relative to their scattering power. Thus, in turn:

\overline{ω}_{W}=K_{W}=(1−R)²/(2*R)

to provide an array of K_{W}, S_{W} values for the white colorant.

The following steps are utilized for the other colorants:

Symbols:

W=White Colorant

B=Black Colorant

A=Colorant

C=Concentration

SG=Specific Gravity (g/ml)

V=Volume

For each wavelength (λ) we calculate K, S as follows:

First, a decision must be made as to whether to use the “Colorant/White Sample” or the “Colorant/Black Sample”. Typically, whichever Reflectance (R) is furthest from Colorant (A) will be used: Black or White.

Absolute (R_{A}−R_{B}) vs. Absolute (R_{A}−R_{W})

If Black is further [Absolute (R_{A}−R_{B})>Absolute (R_{A}−R_{W})]:

Calculate the Unit Concentrations (See Table 1) of Black in the Black/Colorant (C_{BA}) mix and the Black/White (C_{BW}) mix:

C_{BA}=V_{B}/(V_{B}+V_{A})

C_{BW}=V_{B}/(V_{B}+V_{W})

With the arrays discussed above, Calculate S_{AW}, K_{AW}:

S_{AW}=C_{BA}*(1−C_{BW})/C_{BW}*(1−C_{BA})*((\overline{ω}_{BW}−\overline{ω}_{W})/(\overline{ω}_{B}−\overline{ω}_{BW}))*((\overline{ω}_{B}−\overline{ω}_{BA})/(\overline{ω}_{BA}−\overline{ω}_{A}))

K_{AW}=\overline{ω}_{A}*S_{A}

If White is further [Absolute (R_{A}−R_{B})<Absolute (R_{A}−R_{W})]:

Calculate K_{A} relative to the scattering power of White S_{W}:

K_{A}/S_{W}=\overline{ω}_{A}*((\overline{ω}_{AW}−\overline{ω}_{W})/(\overline{ω}_{A}−\overline{ω}_{AW}))

Since S_{W}=1 from earlier:

K_{A}=\overline{ω}_{A}*((\overline{ω}_{AW}−\overline{ω}_{W})/(\overline{ω}_{A}−\overline{ω}_{AW}))

Unit Concentrations of White (C_{WA}) and Colorant (C_{AW}) in their mixture are also required:

C_{WA}=V_{W}/(V_{W}+V_{A})

C_{AW}=1−C_{WA}

Calculate K_{AW}, S_{AW}:

K_{AW}=K_{A}*C_{WA}/C_{AW}

S_{AW}=K_{AW}/\overline{ω}_{A}

K, S arrays for each colorant in the set are now known. These arrays can be directly used in the formulation program 572 to determine the color of any ratio of colorants.

The following discusses the manner in which K, S arrays can be used to determine the color of a given formula.

The total amount of colorant in a mix must add up to 1. For example, [4 ml White, 1 ml Black]=[C_{W}=0.8, C_{B}=0.2]. The following symbols used by the present invention are set forth below.

Symbols:

W=White Colorant

B=Black Colorant

A=Colorant

M=Mixture

C=Concentration

R=Reflectance

For each wavelength (λ) we calculate K_{M}. S_{M} as follows:

K_{M}=K_{WW}+K_{BW}+K_{AW}+ . . . for as many colorants in the mixture=C_{W} \overline{ω}_{W}+C_{B} K_{BW}+C_{A} K_{AW}+ . . .

Similarly:

S_{M}=S_{WW}+S_{BW}+S_{AW}+ . . . for as many colorants in the mixture=C_{W}+C_{B} S_{BW}+C_{A} S_{AW}+ . . .

The Reflectance (% R) at each wavelength (λ) can then be calculated:

R_{M} (%)=(1+(K_{M}/S_{M})−[(K_{M}/S_{M})²+2(K_{M}/S_{M})]^{1/2})*100

Thus, a new Spectral Curve with Reflectance values (% R) at each wavelength (λ) which can be converted into any color space required has been successfully generated Table 1: Volume Fractions (V) or Sample Curves

| | W | B | W | A | W | A | M |
|---|---|---|---|---|---|---|---|
| W | 1 | 0 | .395 | 0 | .379 | 0 | .10 |
| B | 0 | 1 | .605 | 0 | 0 | .047 | .02 |
| A | 0 | 0 | 0 | 1 | .621 | .953 | .88 |

| | W | B | W | A | W | A | M |
|---|---|---|---|---|---|---|---|
| 400 nm | 1.980 | .6591 | 4.169 | .5803 | 0.302 | .2476 | .30 |
| 500 nm | 2.443 | .4649 | 3.060 | .6575 | 2.991 | .2215 | 7.70 |
| 600 nm | 2.207 | .4667 | 1.541 | 0.380 | 5.418 | 7.777 | 3.12 |
| 700 nm | 1.084 | .4810 | 0.457 | 5.662 | 2.866 | 2.869 | 8.65 |

Once the color for an estimated formula has been determined, the formulation program 572 then branches to a step 616 where a minimum match distance is set. By default, the formulation program 572 uses a minimum match distance of 0.5 Delta-E. This means that any color match generated should be within 0.5 Delta-E of the desired color 32. The minimum match distance is freely modifiable allowing for almost a 100% match when set to 0 and given a big enough number of iterations. Due to time efficiency, in one preferred embodiment, the minimum match distance is 0.02. The minimum match distance can be specified by either querying the product provider 25 for a value or by using a predefined value.

The number of iterations through the main logic loop is inversely related to the minimum match distance or target Delta-E value, i.e. the lower the target Delta-E value, the more iterations through the main logic loop can be expected. The target Delta-E value indicates the desired color difference between the desired color 32 and the formulated color. Because, on average, the human eye can generally only see color differences of about Delta-E=0.88, measured in LUV color space, once a Delta-E value of less than 0.88 has been achieved, the human eye generally is not capable of detecting a color difference between the desired color 32 and the formulated color. Therefore, the reference of the specified colorable product 33 having the desired color 32 will be understood to mean the specified colorable product 33 having a color within at least a Delta-E of the minimum match distance of the desired color 32.

Once the minimum match distance is set, the formulation program 572 branches to a step 618. The formulation program 572 uses trial and error to generate the formula 42 from the colorant parameters. That is, mathematic values indicative of a “pigment unit” of one of the pigments in the colorant set are provided to the formula for calculating the Delta-E in a step 620. It must also be pointed out that one of the pigments in the colorant set is the pigment of the base material itself.

The formulation program 572 then branches to a step 622 where the Delta-E calculated in the step 620 is compared to the minimum match distance Delta-E calculated in the step 616. If the Delta-E in the step 622 is less than the minimum match distance in the step 616, the formulation program 572 then branches to a step 624 where the formula 42 is constructed from the pigment units. If the Delta-E is greater than the minimum match distance in the step 616, the formulation program 572 then branches to a step 625 where the formulation program 572 compares Delta-E between the current color and the desired color 32 as obtained in the step 620 against Delta-E between the previous color and the desired color 32 as obtained in the step 620 in a previous iteration. The formulation program 572 then branches to a step 626 where it is determined whether the Delta-E of the current color in the step 620 (current Delta-E) is less than or equal to the Delta-E of the previous color in the step 620 (previous Delta-E). If the current Delta-E in the step 620 is less than the previous Delta-E in the step 620, then the formulation program 572 branches to a step 628 where the pigment unit of the colorant is gradually increased. If the current Delta-E in the step 620 is greater than the previous Delta-E in the step 620, the formulation program 572 branches to a step 629 where another colorant from the colorant set is selected. The formulation program 572 then branches to the step 618 and the before-mentioned process is repeated until the Delta-E in the step 620 is less than the minimum match distance Delta-E in the step 616.

The formulation system 31 should be constructed so as to not allow each colorant in the colorant set to be used more than once. Therefore, step 628 is constructed such that once all colorants in the colorant set have been used and the current Delta-E value in the step 620 is greater than or equal to the previous Delta-E value in the step 620, the logic flow will go to the step 624 as well as indicate to the formulation system 31 that the target Delta-E value (i.e. one that is less than or equal to the minimum match Delta-E in the step 616) could not be obtained. Further, the formulation system 31, in conjunction with the monitor 564 and the computer 560, can then generate and display a window with a message indicating that the target Delta-E could not be obtained so as to notify the product provider 25. The formulation system 31 can further indicate to the product provider 25 the relationship between the “best” obtained Delta-E and the target Delta-E, i.e. the color difference between the formulated color and the desired color, for example, by rating the difference using a predetermined scale, so that the product provider 25 can then determine whether to continue or alert the consumer 20.

Once the logic flow reaches the step 624, the formula 42 is then determined by converting the number of pigment units determined for each colorant in the colorant set, which will be the number of iterations through the step 618 for each colorant, into real-world measurable units for each colorant by using predetermined pigment to real-world measurable unit ratios. The pigment unit for each colorant is preferably either in terms of mass or volume, so that the pigment units determined for each colorant can be multiplied by a predetermined specific gravity conversion factor for each of the colorants so as to determine the volume or weight, respectively, of each of the colorants needed to collectively produce the volumetric or by-weight formula, respectively.

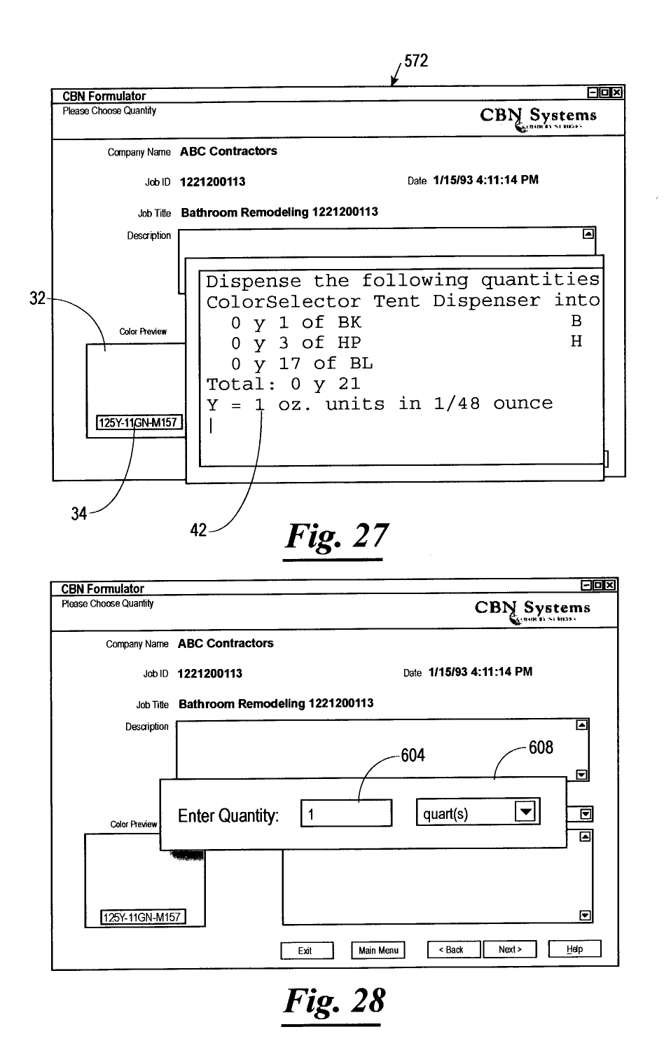

The formula 42, which contains the volumetric or weight units for each colorant that is to be combined and used to color the specified colorable product 33, is then provided to the product provider 25. The formulation program 572 generally outputs the formula 42 to the monitor 564 so as to provide the product provider 25 with the formula 42, such as shown in FIG. 27. However, the formulation program 572 can also output the formula 42 to the output device, such as the printer, or to another program, such as a colorant dispenser control program or to the colorant dispenser itself.

Once the product provider 25 receives the formula 42, the product provider 25 utilizes the formula 42 in making the specified colorable product 33 having the desired color 32. For example, the product provider 25 can set up a tint dispenser containing a colorant set to disperse an amount of each colorant corresponding to the volumetric units in the formula 42 into a base material for the specified colorable product 33, mix the base material and added colorants thereby coloring the specified colorable product 33 such that the specified colorable product 33 has the desired color 32, and then provide the specified colorable product 33 having the desired color 32 to the consumer 20. Any colorant dispensing techniques using any substance which effects the color of a mixture and that can be measured using K and S values can also be utilized by the product provider 25 in conjunction with the formula 42 to make the specified colorable product 33 having the desired color 32, such as for example, those which are well known in the art as color pack methods, dry additive pigments methods, and methods using liquid-based colorants and or dyes, such as glycol-based colorants, food colorings or dyes. Generally the consumer 20 will provide the product provider 25 with consideration for the specified colorable product 33 having the desired color 32.

In another preferred embodiment, shown in FIG. 29b, the main logic loop of the formulation system 31 incorporates other variables or heuristic criteria when generating the formula 42, such as pigment price, the number of pigments used in the formula 42, total volume of the pigments used in the formula 42, total cost of the formula 42, and quality relative to hide and color fastness, in addition to match distance or closeness of formulated color to desired color 32. As will be discussed below, in this embodiment, the formulation system 31 uses the heuristic criteria in an effort to optimize the formula 42 to match the desired color 32 in the most cost-effective manner using the least amount of volume of the least number pigments that gives an acceptable or target level of hide or fastness.

For each type of colorable product 33, the sequencing of the main logic loop is essentially the same, with the difference being the colorant set to be used, the formulas corresponding to the colorant set, and the corresponding algorithms associated with the heuristic criteria of the colorant set.

As shown in FIG. 29b, upon initiation, the step 610 (the same as in FIG. 29a) of the main logic loop branches to a step 630. In the step 630, the input data, such as color code 34, is decoded so as to convert the input data into the value that is relative to LUV color space for the desired color 32. Alternatively other color information indicative of the input data, such as color space values or spectral frequency values, can be inputted into the formulation program 572. Step 630 of FIG. 29b is analogous to step 612 of FIG. 29a.

Once the formulation program 572 receives the color information indicative of the desired color 32, the formulation program 572 branches to a step 632 where the formulation program 572 produces and records an estimated color formulation for the desired color 32. In one preferred embodiment, the formulation program 572 includes a start colors database 634. As shown in FIG. 29b, the start colors database 634 is produced by: (1) determining the K, S arrays for the colorant set, including the base material; (2) producing an arbitrary plurality of colorant formulas formed of combinations of colorants (e.g. 1, 2, 3, . . . colorants) in the colorant set; and (3) converting each of the colorant formulas to an estimated color as indicated by the steps 636, 638 and 640. The estimated colors and the formulas for producing the estimated colors are stored in the database of start colors 634—i.e. for each estimated color (i.e. record) in the start colors database 634, a formulation and associated LUV value is stored in the start colors database 634.

In the step 632, the formulation program 572 evaluates the formulation in every record in the start colors database 634 with respect to the desired color 32 as well as zero or more of the heuristic criterion (as discussed in more detail below). The evaluation of each record results in a “search cost”. The search cost represents a value or score indicative of how well the formulation corresponds to the heuristic criterion including the heuristic criteria for the color match. Ideally, formulations which match most closely with the desired color 32 (possibly weighted with the other heuristic criterion) will be considered as having a “low” search cost.

Then, the start colors database 634 is optionally reordered (e.g., from best to worst, or from worst to best) based on the search costs resulting from the evaluation. In one preferred embodiment, the records in the start colors database 634 are evaluated using only the heuristic criteria for Delta-E and thus, the start colors database 634 is reordered based upon the closeness of each color in the database 634 relative to the desired color 32. In another preferred embodiment, each record in the start colors database 634 is evaluated with the desired color and the other heuristic criterion using the same weighting ratios discussed below for evaluating estimated or modified formulas. The main loop of the algorithm is then entered and the first (or last) record in the database 634 (i.e. the record evaluated to have the lowest search cost) is used as a start point. The formulation program 572 thereafter branches to the step 642 where the start point is recorded as the estimated color formulation as well as the estimated color formulation's search cost.

Exemplary graphs of heuristic criterion are shown in FIGS. 29c, 29d, 29e, 29f and 29g. FIG. 29c is a curve representing the “cost” of the total amount of colorant in a formulation. As the total amount of color increases, the cost also increases. FIG. 29d is a curve representing the “cost” of the quality of the formulation relative to hide and color fastness. FIG. 29e is a curve representing the estimated monetary cost of the colorants in the formulation. FIG. 29f is a curve representing the “cost” of the estimated match distance to desired color 32. FIG. 29g is a curve representing the “cost” of the number of pigments in the formulation.

Each of the heuristic criterions outlined graphically in FIGS. 29c-29g can be represented as a curve plotted in the positive X and Y coordinate quadrant of a standard Cartesian coordinate system that equates a real value in a specific criterion to an arbitrary decimal value between 0 and 1 and is a monotonic function of the real (input) value. As such, each of the curves can be classified as an admissible heuristic.

The Y axis for all curves is plotted from 0.0 to 1.0. The X axis is plotted with respect to the heuristic being evaluated, always starting from a theoretical minimum value extending to the theoretical maximum value. For example, with respect to Delta-E, it is known that the theoretical maximum Delta-E that can be computed between two colors in LUV space is approximately 300 (FIG. 29f).

The exact shape of the curve is determined by knowledge engineering executed in the technical lab, color scientists, and industry specialists in the field of creating “good” color formula for a given material. When the perceived negative cost of a single change in a given heuristic criteria is minimal, the curve is shaped with a small slope. As the perceived negative cost of a single change in a given heuristic criteria is greater, the curve is shaped with a steeper slope. Thus, in practice, all curves tend to be sinusoidal.

For example, with respect to the Delta-E heuristic curve, a zero Delta-E is the theoretical minimum, so this is plotted at point 0 on the Y axis. Since most people cannot perceive the difference between a Delta-E of 0.05 and 0.01, the shape of the curve at this point has a minimal slope. This slope is carried toward the next breakpoint which is approximated at 0.75. This value was chosen since most people can begin to see a slight difference in color at 0.75. After 0.75, the slope of the curve is steeper to reflect the heuristic that additional changes in Delta-E come with a relatively high “cost” associated. This process is continued such that the “cost” associated with increasing values of X is relative to increasing values of Y. Additionally, each heuristic criteria is assigned a “weight” which is a representation of that heuristics criteria's relative importance in evaluating the search cost of a given formula relative to the other heuristics. For example if each heuristic is given an equal weight, then the “cost” associated with an increasing cost factor from a given heuristic contributes equally to the evaluation of a given formulas “search cost” relative to the “cost” associated with an increasing cost of any other heuristic. Alternatively, if one heuristic is weighted twice as much as an other, then the “cost” associated with an increasing cost factor from the first (greater weight) heuristic contributes twice as much to the evaluation of a given formulas “search cost” relative to the “cost” associated with an increasing cost of the second heuristic.

Typically, each of the heuristic criterion are provided with a predetermined weighting ratio where color match is weighted to 96%, dollar-cost is weighted to 2% number of pigments is weighted to 1.5%, volume of pigment is weighted to 0.25%, quality of hide and fastness together are weighted to 0.25%. This weighting determines the search-cost of each color formulation. However, the formulation program 572 can be programmed to re-prioritize the heuristic criterion in any weighting ratio configuration desired. This allows the formulation system 31 to generate the formula 42 to meet more specific requirements or needs of the product provider 25, or consumer 20. For example, if the main concern of the product provider 25, or consumer 20, is having a low total cost, the formulation system 31 can evaluate possible formulas wherein finding the formula with the lowest total cost is scaled so as to have relatively more importance than the other variables—i.e providing a search cost for each formula, wherein the search cost of the “best” formula is weighted to favor the lowest total cost of producing the formula.

Once the estimated formula is tested with the heuristic criterion to evaluate its search-cost, the formulation program 572 branches to a step 644, where the formulation program 572 uses the estimated formula to create a plurality of modified formulas. The modified formulas are created by: (1) adding a small amount (such as 1/48 oz.) of each pigment to the estimated formula; and (2) subtracting a small amount (such as 1/48 oz.) of each pigment from the estimated formula. Thus, if the colorant set includes 12 colorants, 24 modified formulas will be created. The step 644 can be implemented utilizing an algorithm known in the art as a gradient descent algorithm.

The formulation program 572 thereafter branches to a step 646 where each of the modified formulas is tested in a similar manner as the estimated formula was tested in the step 642. The formulation program 572 then branches to a step 648 where a “best” color formulation is determined based on a comparison of the search-cost for each of the modified formulas with the search cost of the estimated formula. The Formulation program 572 then branches to step 649 to determine if a better formula has been created or not. If a subsequent formula that is created has a lower search-cost than the current “best” formula (or estimate), then this subsequent new formula moves up and replaces the old formula as the “best” formula (or estimate) and the program branches to step 650. If a better formula has not been created, the plurality of estimated formulae created in 644 is completely discarded (retaining the single “best” estimate so far).

The formulation program 572 then branches to a step 649b where the next available record from the start colors database 634 is retrieved as the next candidate for evaluation. The formulation program 572 then branches to the step 644 where this candidate is used to repeat the process and create a new plurality of formulae. In step 650 the formulation program 572 determines whether a predetermined number of iterations has been reached, and if not, the formulation program 572 branches to the step 644 where the process is repeated. If the predetermined number of iterations has been reached, the formulation program 572 branches to a step 652 where the “best” color formulation is output. In the step 652, the real-world volumetric, or by-weight formula 42 is determined based on the “best” color formulation, in the same manner as the real-world formula is determined for step 624 of the main logic loop shown in FIG. 29a, as discussed above.

In theory, the formulation program 572 could continue optimizing the “best” color formulation into infinity. To prevent this from occurring, the number of iterations is typically set at a number of about 300 where it has been determined that suitable formulas have been produced. The number of iterations could be increased or decreased in an attempt to increase or decrease the quality of the “best” color formulation.

Although the heuristic criteria are shown in FIGS. 29c-29g as line drawings to optimize computational efficiency, because they are (potentially) evaluated several million times in a single search cycle, it should be understood that other manners can be used to form the heuristic criteria. For example, the heuristic criteria can be implemented using calculus or polynomial trigonometric functions.

In summary, the formulation program 572 is programmed to dynamically generate a new and unique formula (volumetrically or by-weight) for a specific (but arbitrary) material type, and specific (but arbitrary) colorant set that, when combined and mixed adequately, will accurately produce the desired color 32 represented by the color code 34 (from the visual electromagnetic spectrum)—given that the base material(s) and/or colorant set have the capability of producing the desired color 32. In the case of base material(s) and/or color set(s) that have limited possible color gamut (i.e. those with a significant color cast or hue to the base material; e.g. concrete having a gray cast that prevents the formulation of “bright” colored concrete formulations), the formulation program 572 will produce a formula that provides the closest possible color achievable under the given conditions of the base material. Further, this formula will exhibit all the desirable tertiary characteristics (characteristics aside from color match, and relative to the specific material type) that are considered minimally acceptable in a given formula type, in addition to maximizing the desirable characteristics themselves.

The formulation program 572 can further contain a formulation color specification system which allows a color to be specified and then provides the color code 34 corresponding to the desired color 32 which the product provider 25 can then input into the Input CBN field 596 of the Input CBN sub-menu 592 for generating the formula 42 for making the specified colorable product 33 having the desired color 32, or alternatively, the color code 34 can be automatically inputted into the Input CBN field 596 of the Input CBN sub-menu 592.

Having the formulation color specification system incorporated into the formulation system 31 allows the formulation system 31 to be used by the product provider 25 to assist the consumer 20 in specifying the desired color 32 for the specified colorable product 33 or as a point-of-sale marketing tool wherein the consumer 20, as a customer of the product provider 25, can use the formulation system 31 when the product provider 25 is not using the formulation system 31 to generate formulas. In one preferred embodiment, the formulation system 31 can query the product provider 25 for a password so that contents within the formulation system 31 can be protected when the formulation system 31 is in customer-use mode. The formulation color specification system can be implemented essentially in the same manner as the color selector 174 provided by the specifier program 56 of the color specification system 30, as described above, wherein the formulation color specification system provides the product provider 25, or consumer 20, at least one of a database of selectable colors from which the product provider 25, or consumer 20, can specify a color, or by querying input indicative of a color from the product provider 25, or consumer 20, so as to obtain color information of the desired color 32, such as for example, RGB values or HTML values, or spectral frequency values. The formulation color specification system then manipulates the color information with predefined encoding equations so as to generate and provide the color code 34 from which color information of the desired color 32 can be obtained by the formulation system 31 once decoded.

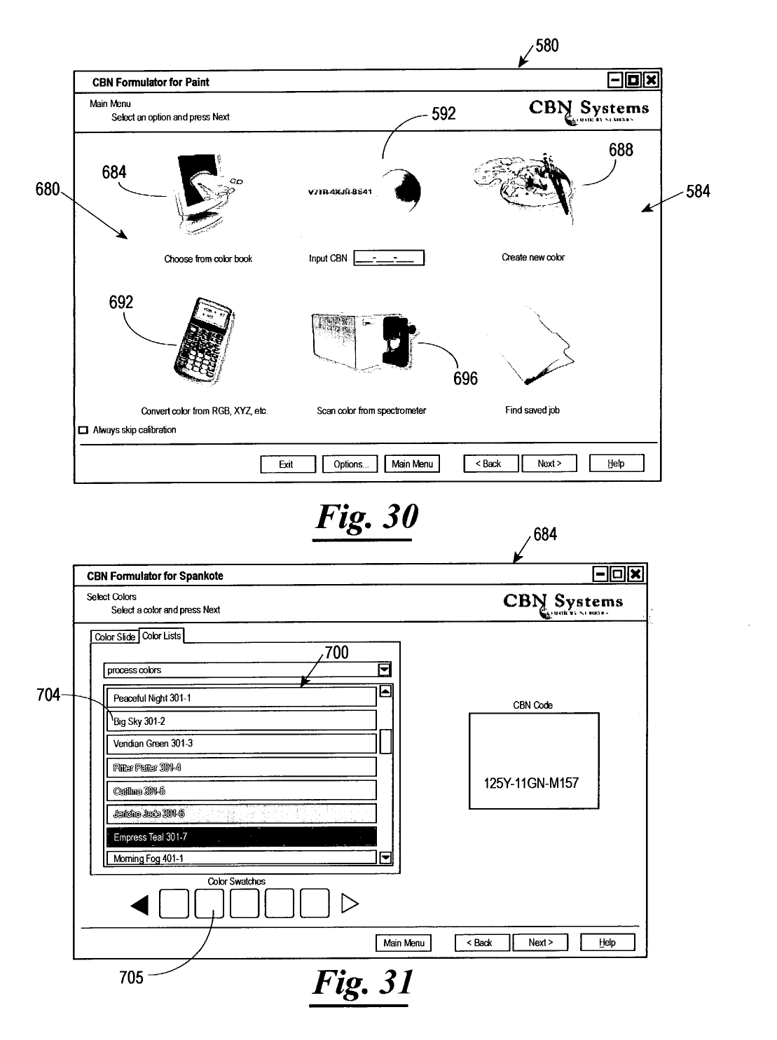

In one preferred embodiment, the formulation color specification system is incorporated into the formulator main menu 584 for the formulation program 572. For example, in FIG. 30, shown therein is a formulation color specification system 680 which is incorporated into the formulator main menu 584 by including in the formulator main menu 584 a link for selecting a Choose From Color Book sub-menu 684, a link for selecting a Create New Color sub-menu 688, a link for selecting a Convert Color From RGB sub-menu 692, and a link for selecting a Scan Color From Spectrometer sub-menu 696. The Choose From Color Book sub-menu 684 allows the product provider 25, or consumer 20, to specify the desired color 32 by selecting a color from a database of selectable colors, and the Create New Color sub-menu 688, the Convert Color From RGB sub-menu 692, and the Scan Color From Spectrometer sub-menu 696 allow the product provider 25, or consumer 20, to specify the desired color 32 by querying input indicative of the desired color 32 from the product provider 25, or consumer 20, so as to obtain color information of the desired color 32.

Referring now to FIG. 31, shown therein is the Choose From Color Book sub-menu 684, which includes a color display sub-menu 700, wherein the database of selectable colors is displayed in pictorial and/or alphanumerical form and in two-dimensional form in a color chart 704 of selectable colors for a plurality of materials for colorable products 33, such as by way of example but not limitation, paint, stain, caulk, sealant, concrete, grout, mortar, bricks, pavers, and roof tiles. In such an embodiment, the selectable colors for the plurality of materials for colorable products 33 displayed can be existing colors for the materials that have been predefined in each respective industry. The product provider 25, or consumer 20, can utilize the input device 568, such as a mouse 706 (see FIG. 24), to specify a material and then select a color from the color chart 704 to indicate to the formulation program 572 that a color has been specified so that the color information corresponding to the desired color 32 can be utilized by the formulation program 572 to generate and provide the color code 34 corresponding to the desired color 32. Color swatches 705 display a selection of brighter and darker colors achievable relative to the estimated formula to provide the product provider 25 alternatives to the desired color which are in the same color family but are lighter or darker so as to provide more choices for the consumer 20. These alternatives are generated from the estimated formula by adding and/or subtracting white and/or black in arbitrary (but monotonically increasing or decreasing) amounts to the estimated formula. Each alternative formula is then analyzed for its predicted color as outlined. The resulting colors are displayed in the color swatches 705.

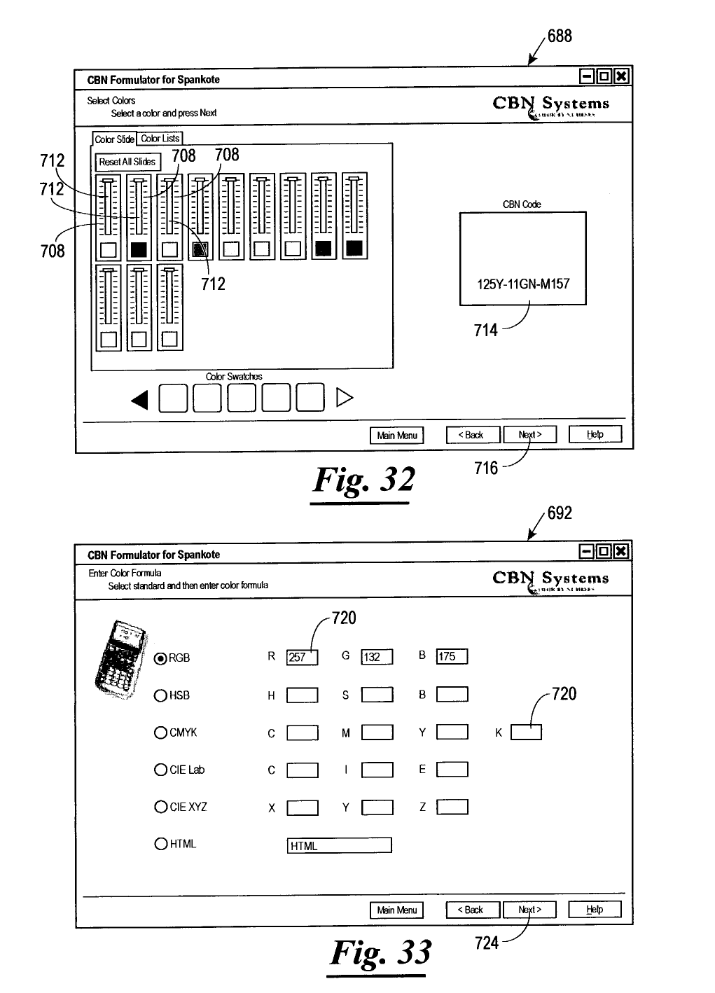

Referring now to FIG. 32, shown therein is the Create New Color sub-menu 688, whereby the product provider 25, or consumer 20, utilizes the input device 568, such as the mouse 706, in conjunction with a plurality of color sliders 708 (only three of the color sliders 708 being numbered in FIG. 32 for purposes of clarity), wherein each color slider 708 corresponds to a color in a predefined set of colors (i.e. the colorant set for the base material), to set a level indicator 712 for each of the color sliders 708 at a value whereby the slider indicator value indicates the ratio value of the color with respect to the other colors in the set of colors. The ratio values in combination with the K and S values for each of the colors in the set of colors is then used by the formulation program 572 to determine the color specified. Further, the formulation program 572 can display 714 the specified color, as determined by the value of the level indicators 712, to the product provider 25, or consumer 20, so that the product provider 25, or consumer 20, can utilize the display in setting the level indicator 712 for each color slider 708.

Once the product provider 25, or consumer 20, sets the level indicators 712 for the plurality of color sliders 708 so as to specify a color, the product provider 25, or consumer 20, utilizes a Next button 716 to indicate to the formulation program 572 that a color has been specified so that the color information corresponding to the desired color 32 can be utilized by the formulation program 572 to generate and provide the color code 34 corresponding to the desired color 32. Though the Create New Color sub-menu 688 is described as being incorporated into the formulation program 572 of the formulation system 31, the Create New Color sub-menu 688 can also be adapted to be utilized in the specifier program 56 of the color specification system 30.

Referring now to FIG. 33, shown therein is the Convert Color From RGB sub-menu 692, whereby the product provider 25, or the consumer 20, is queried to input information that is indicative of the desired color 32, such as color space values relating to the desired color 32, into a plurality of color conversion input fields 720 (only two being numbered for purposes of clarity). For example, the input indicative of a color can be the alphanumerical value of the desired color 32 in a color space, such as by way of example but not limitation, the RGB color space value, the CMYK color space value, the HSB color space value, the CIE LAB color space value, the CIE XYZ color space value, or HTML color space value. The consumer 20 can provide the input indicative of the desired color 32 by utilizing the input device 568, such as a mouse 706 and/or keyboard 722 (see FIG. 24), to input alphanumeric values into the appropriate color conversion input fields 720, and then utilize a Next button 724 to indicate to the formulation program 572 that a color has been specified so that the color information corresponding to the desired color 32 can be utilized by the formulation program 572 to generate and provide the color code 34 corresponding to the desired color 32.

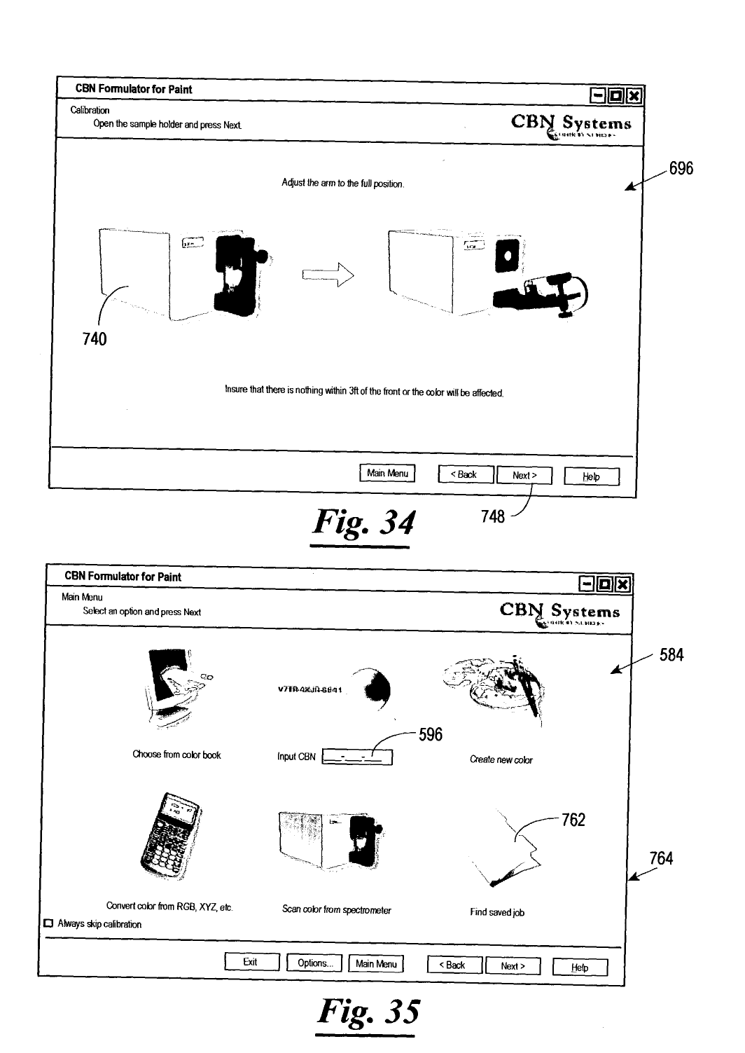

Referring now to FIG. 34, shown therein is the Scan Color From Spectrometer sub-menu 696, whereby the product provider 25, or consumer 20, can utilize a scan color button 740, in conjunction with input devices 568, such as the mouse 706, and a spectrometer 744 (see FIG. 24) to input color information of the desired color 32 into the formulation program 572, wherein the color information comprises the spectral frequency measurement outputted by the spectrometer 744 for a colored sample having the desired color 32 (not shown) which was placed within the spectrometer 744 for the making of the spectral frequency measurement. Use of a spectrometer to obtain a frequency measurement for a colored sample is well known in the art, therefore, no further discussion is deemed necessary.

Once the spectral frequency measurement outputted by the spectrometer 744 is inputted into the formulation program 572, the product provider 25, or consumer 20, utilizes a Next button 748, to indicate to the formulation program 572 that a color has been specified so that the color information corresponding to the desired color 32 can be utilized by the formulation program 572 to generate and provide the color code 34 corresponding to the desired color 32. Though the Scan Color From Spectrometer sub-menu 696 is described as being incorporated into the formulation program 572 of the formulation system 31, the Scan Color From Spectrometer sub-menu 696 can also be adapted to be utilized in the specifier program 56 of the color specification system 30. However, since the spectrometer 744 is generally a high-cost tool, the Scan Color From Spectrometer sub-menu 696 is preferably only incorporated into the formulation program 572 of the formulation system 31, which is intended to be primarily used by the product provider 25.

The formulation program 572 can further include a customer information system for labeling and storing customer purchase information, such as by way of example but not limitation, a consumer name, a project name, a project description, the specified colorable product 33, the desired color 32 for the specified colorable product 33, the color code 34 corresponding to the desired color 32, a quantity of the specified colorable product 33 purchased, a purchase date, and the formula 42 used by the product provider 25 in making the specified colorable product 33 having the desired color 32, on the computer 560 so that customer purchase information can be readily obtained by the product provider 25, displayed on the monitor 564, and/or printed out on the printer.

In one preferred embodiment, the customer information system is incorporated into the formulator main menu 584 for the formulation program 572. For example, in FIG. 35, shown therein is a customer information system 762 which is incorporated into the formulation main menu 565 for the formulation program 572 by including a link for selecting a Find Saved Job sub-menu 764.

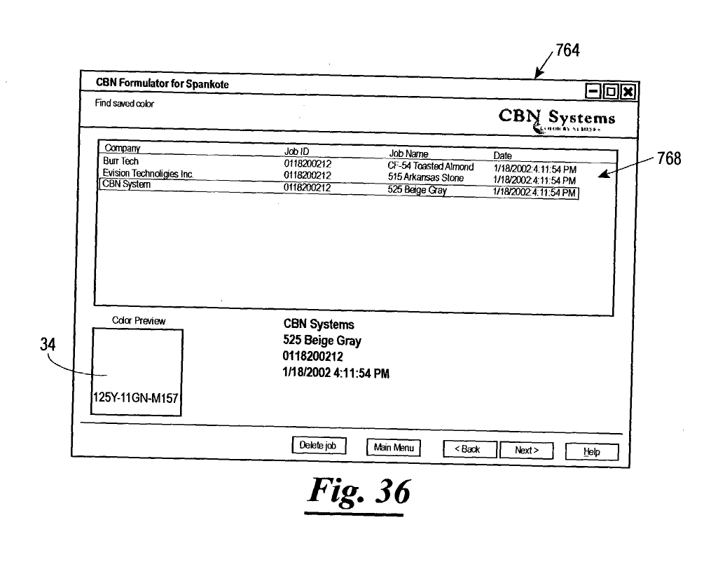

Referring now to FIG. 36, shown therein is the Find Saved Job sub-menu 764, whereby the product provider 25 selects a labeled customer's sub-menu 768 from a list of a plurality of labeled customers' sub-menus 768, wherein each labeled customer's sub-menu 768 contains customer purchase information that has been previously labeled and stored on the computer 560. From the customer purchase information within a labeled customer's sub-menu 768, the product provider 25 can obtain the color code 34 corresponding to a previously desired color 32, or alternatively, the formula 42 for making the specified colorable product 33 having the desired color 32.

Once the formulation color specification system 572 generates and provides the color code 34, the product provider 25 can utilize the color code 34 in generating the formula 42 for making a specified colorable product 33 having the desired color 32 by inputting the color code 34 into the Input CBN field 596 of the Input CBN sub-menu 592, or alternatively, the color code 34 can be automatically inputted into the Input CBN field 596 of the Input CBN sub-menu 592 by the formulation program 572. The Input CBN sub-menu 592 will then continue on to query the product provider 25 for information of the type of colorable product 33, as discussed above. The formulation system 31 will use that information in sequencing the main logic loop for generating the formula 42 and will generate and provide the product provider 25 with the formula 42 for making the specified colorable product 33 having the desired color 32, as also discussed above. The product provider 25 can then input the quantity of colorable product 33, and units of the quantity as discussed above.

The formulation system 31 can further contain the monitoring system 46 (see FIG. 1) whereby information of the usage of the formulation system 31 by the product provider 25 and the sales transactions between the product provider 25 and the consumer 20 can be transmitted via the Internet, or some other communication channel, to the host 15 so that the host 15 can use the information for royalty fee determinations and/or for market feedback assessment for determining such things as whether new features need to be added to existing tools or whether a re-write of existing tools needs to be considered. The formulation system 31 can further comprise an application programming interface which would allow product providers 25 to integrate the monitoring system 46 into their own business accounting and analysis system.

Thus, it can be seen that the present invention, by providing one standardized color code 34 for the desired color 32 and, by utilizing the formulation system 31 that generates the formula 42 based on the type of colorable product specified, allows the consumer 20 to communicate the color code 34 to the product provider 25 and then specify one or more specified colorable products 33, in differing or same amounts, to be colored to have the desired color 32, and thereby allows the product provider 25 to provide matching colors across multiple colorable products to the consumer 20.

The following examples of the operation of the affiliation 10 are set forth hereinafter. It is to be understood that the examples are for illustrative purposes only and are not to be construed as limiting the scope of the invention as described and claimed herein.

### EXAMPLE 1

The consumer 20, who is an individual, is interested in repainting his living room. The consumer 20 can download software for the specifier program 56 from a website maintained by the host 15. The consumer 20 then takes a digital picture of his living room, loads the image 140 of his living room into the specifier program 56. After recoloring the image with paint colors selectable in the specifier program 56, he makes a decision of which color to paint his living room and writes down or prints out the color code 34 corresponding to the desired color 32. He then communicates the color code 34 to a local product provider 25, such as a local home improvement store, to order the paint to be colored to have the desired color 32. He then waits at the store as the product provider 25 generates the formula 42 using the formulation system 31 and mixes the paint with the appropriate amounts of colorants in the colorant set as provided in the formula 42. The product provider 25 then provides the paint having the desired color 32 to the consumer 20 in exchange for money. The consumer 20 also decides that he would like a stain in the same color as the paint so that he can match his wooden furniture to the paint for his living room. The product provider 25 uses the same color code 34 to generate the formula 42 for the stain, makes the stain having the desired color 32, and provides the stain having the desired color 32 to the consumer 20.

### EXAMPLE 2

The consumer 20, who is a design professional; such as an interior designer, at her work station, downloads the software for the specifier program 56 from a CD she received in the mail from the host 15. No longer limited to color chips or color swatches, the designer now has virtual color availability through the use of the specifier program 56 to select desired colors 32, recolor images 140, or work within an existing design program, thereby increasing her work productivity and efficiency. The designer specifies a custom color for the project and uses the specifier program 56 to print out the color specification report 530 listing the project details and color codes 34 of desired colors 32 for the specified colorable products 33 to be used within the project. The designer then gives the color specification report 530 to the contractor working on the project. The contractor calls or emails the product provider 25, such as a distributor, and gives the details of the color codes 34 for the desired colors 32 for the specified colorable products 33, such as paint, cement, grout, caulk, pavers, and ceramic tiles, needed for the project. The distributor sends the order to the appropriate factories who will use the color codes 34 to generate formulas 42, make the specified colorable products 33 having the desired colors 32, and ship the specified colorable products 33 having the desired colors 32 to the distributor (or to the contractor or designer). The distributor can then send the specified colorable products 33, individually or in bulk, to the contractor or designer in exchange for money.

Although the present invention has been described herein as being used for coloring colorable products generally within the construction materials industry, it should be understood that the present invention can be suitable for any industry having colorable products, such as for example but not by way of limitation, the automotive industry (e.g. exterior paint, interior carpet, interior moldings, window tint, seat coverings), the cosmetics industry (e.g. lipstick, eye makeup, nail polish), the textile and fashion industry (e.g. fabrics and leathers for clothing, belts, shoes, purses), the plastics industry, the paper industry, the printing industry, and the food industry.

Changes may be made in the embodiments of the invention described herein, or in the parts or the elements of the embodiments described herein or in the step or sequence of steps of the methods described herein, without departing from the spirit and/or the scope of the invention as defined in the following claims.

What is claimed:

1. A method for directing a consumer to obtain a colorable product from a product provider within an affiliation, comprising the steps of:
providing the consumer with a color specification system whereby the consumer specifies a desired color for at least one colorable product and the color specification system outputs a color code comprising encrypted data indicative of the desired color; and
directing the consumer to communicate the color code to a product provider within the affiliation.

2. The method of claim 1, further comprising the steps of decoding the color code and generating a formula for making the specified product having the desired color so that the product provider can utilize the formula to make a specified colorable product having the desired color.

3. The method of claim 2, wherein the one decoded color code is used to generate a plurality of formulas for making a plurality of colorable products, respectively, all having the single desired color.

4. The method of claim 1, wherein the method further comprises a step of monitoring the exchange between the product provider and the consumer for the purpose of billing at least one of the product provider or consumer by a host of the affiliation.

5. The method of claim 1, wherein the step of providing the consumer with the color specification system is defined further as providing computer software to the consumer wherein the computer software enables the consumer to specify the desired color by at least one of selecting from a database of selectable colors and inputting data comprising color information for the desired color into the software.

6. The method of claim 5, wherein the computer software is provided to the consumer via the Internet.

7. The method of claim 5, wherein the computer software is provided to the consumer free of charge.

8. The method of claim 5, wherein the database of selectable colors is a three-dimensional representation of selectable colors for the specified product.

9. The method of claim 8, wherein the three-dimensional representation of selectable colors for the specified product is a sphere.

10. The method of claim 5, wherein the color specification system further enables the consumer to use at least one of a plurality of different types of hardware to input data into the computer software.

11. The method of claim 10, wherein the plurality of hardware includes at least one of a computer, keyboard, mouse, microphone, joy stick, game pad, satellite dish, digital camera, scanner, spectrophotometer, and monitor.

12. The method of claim 1, wherein in the step of providing the color specification system, the color specification system further comprises a color selector for selecting a pixel on a monitor to provide color information for the desired color.

13. The method of claim 1, wherein the encrypted data indicative of the desired color is an alphanumeric code comprising combinations of symbols.

14. The method of claim 1, wherein the colorable product is selected from a group consisting of paint, stain, concrete, glass, plastics, textiles, brick, stucco, grout, sealant, caulk, cement, acrylics, cosmetics, food, textiles, plastics, paper, and printings.

15. A method for obtaining at least one specified colorable product, comprising the steps of:
loading an image into a color specification system;
specifying at least one color area within the image;
selecting a desired color for the color area; and
obtaining the at least one specified colorable product having the desired color.

16. The method of claim 15, wherein the step of selecting the desired color is defined further as selecting a pixel on a monitor to specify the desired color.

17. The method of claim 15, wherein the step of obtaining the specified colorable product is defined further as the steps of obtaining a color code indicative of the desired color.

18. The method of claim 17, further comprising the step of obtaining another type of specified colorable product having the desired color from a second product provider.

19. The method of claim 18, wherein the specified colorable products are both obtained utilizing the color code.

20. The method of claim 17, wherein the color code comprises encrypted data.

21. The method of claim 15, wherein the step of specifying at least one color area is defined further as specifying at least two different color areas, and wherein the step of specifying the desired color for the color area is defined further as specifying a desired color for each of the at least two different color areas.

22. The method of claim 21, wherein the step of obtaining the specified colorable product is defined further as obtaining a color code for each of the color areas, the color codes each including encrypted data indicative of the desired colors.

23. A method, comprising the step of:
providing a formulator program, the formulator program identifying at least one product, the product associated with a predetermined colorant set such that upon receipt of a color code the formulator program generates a formula for coloring the at least one product a desired color indicated by the color code.

24. The method of claim 23, wherein formulator program identifies a plurality of different products, each of the products associated with a predetermined colorant set such that upon receipt of a color code and an identification of one of the products, the formulator program generates a formula for coloring the identified product a desired color indicated by the color code.

25. The method of claim 23, wherein the step of providing the formulator program is defined further as providing the formulator program having a color selector for generating the color code.

26. The method of claim 24, wherein at least one of the products is paint.

27. The method of claim 23, further comprising the steps of:
receiving a color code and an identification of one of the products;
generating a formula for coloring the identified product with the desired color upon receipt of the color code.

28. The method of claim 27, further comprising the step of providing a specified colorable product produced in accordance with the formula.

29. A method, comprising the step of:
receiving a formulator program, the formulator program programmed to decrypt a color code indicative of a desired color and generate a formula for coloring a product the desired color indicated by the color code.

30. The method of claim 29, wherein the step of receiving the formulator program is defined further as receiving the formulator program having a color selector for generating the color code.

31. The method of claim 29, wherein the product is paint.

32. The method of claim 29, further comprising the steps of:
receiving a color code; and
generating a formula for coloring the product with the desired color.

33. The method of claim 32, further comprising the step of providing a specified colorable product produced in accordance with the formula.

34. The method of claim 29, wherein the formulator program includes an identification of a plurality of different products, each of the products associated with a predetermined colorant set such that upon receipt of the color code and an identification of one of the products, the formulator program generates the formula.

35. A method for obtaining a specified colorable product, comprising the steps of:
loading an image into a color specification system;
specifying at least one color area within the image;
selecting a desired color for the color area;
obtaining a color code indicative of the desired color; and
obtaining the specified colorable product having the desired color based on the color code.
